SEQUENCE LISTING (16 sequences)

SEQ ID NO: 1 - protein, 4 aa, Artificial
  Artificial sequence for tyrosine bonding
XYYX

SEQ ID NO: 2 - protein, 10 aa, Artificial
  Artificial sequence for tyrosine bonding
XQXGXYPTSX

SEQ ID NO: 3 - protein, 10 aa, Artificial
  Artificial sequence for tyrosine bonding
XQXGYXPTSX

SEQ ID NO: 4 - protein, 16 aa, Artificial
  Artificial sequence for tyrosine bonding
XGQGQXGXYPTSXQQX

SEQ ID NO: 5 - protein, 16 aa, Artificial
  Artificial sequence for tyrosine bonding
XGQGQXGYXPTSXQQX

SEQ ID NO: 6 - DNA, 1176 bp, Triticum sp.
ggcacgaggtcacacacaaggagagaggagatggctcgtgctcctctgctagcagcacttgtggtggcggtggtagtggccagctcgcttgggcatggggcttctgcagcggagcctccggtggcgcgcggcctgtcgttcgacttctaccggcggacctgcccgcgggcggagtccatcgtgcgcggcttcgtccaggacgccgtgcgcaaggacatcggcctcgccgcaggcctcctccgcctccacttccacgactgcttcgtgcagggctgcgacgcctccgtgctcctcgacggctcggccacggggccaggggagcagcaggcgccgcccaacctcaccctccgcccctcggccttcaaggccgtcaacgacatccgcgaccggctggagcgcgagtgccgcggcgccgtcgtctcctgcgccgacatcctcgcgctcgccgcccgcgactccgtggtcgtctccggcgggcccgactaccgcgtgcctcttggccgccgtgacagccgcaggttcgccacgcggcaggacgtgctgtccgacctgccggcgccctcctcgaacgtgccgtccctcctcgccctgctccggcccctcggtctcgacgccaccgacctcgtcacgatctctggcggccacaccatcgggcaggcgcactgctccttcttcgaggaccggctcttccctcgtcccgaccccaccatcaaccccccattcctcgctaggctgaaggggacgtgccctgccaagggcaccgaccgacgcaccgtgctggacgtgcgcacgcccaacgtgttcgacaaccagtactatgtcgacctggtgaaccgggaggggctcttcgtctccgaccaggacctcttcaccaacgacatcacccggcccatcgttgagcgctttgcacgaagccagcgggacttcttcgagcagttcggcgtgtccatgggcaagatgggccagatgagggtgcgcaccagcgacctgggagaggtccgccggaactgctccgcccgcaaccccggcccagccgccgccgacgagctccagtggccgtcctttgtgcagaccatcgtcgatgcagctgcagaaaggcttggctagcttgtaagcatctagacaagtggactagtagctgttaatcatgtcgaaataataaaagtgaacaaacct

SEQ ID NO: 7 - protein, 358 aa, Triticum sp.
MARAPLLAALVVAVVVASSLGHGASAAEPPVARGLSFDFYRRTCPRAESIVRGFVQDAVRKDIGLAAGLLRLHFHDCFVQGCDASVLLDGSATGPGEQQAPPNLTLRPSAFKAVNDIRDRLERECRGAVVSCADILALAARDSVVVSGGPDYRVPLGRRDSRRFATRQDVLSDLPAPSSNVPSLLALLRPLGLDATDLVTISGGHTIGQAHCSFFEDRLFPRPDPTINPPFLARLKGTCPAKGTDRRTVLDVRTPNVFDNQYYVDLVNREGLFVSDQDLFTNDITRPIVERFARSQRDFFEQFGVSMGKMGQMRVRTSDLGEVRRNCSARNPGPAAADELQWPSFVQTIVDAAAERLG

SEQ ID NO: 8 - protein, 5 aa, Artificial
  Artificial sequence for tyrosine bonding
YYPTS

SEQ ID NO: 9 - protein, 8 aa, Artificial
  Artificial sequence for tyrosine bonding
QQGYYPTS

SEQ ID NO: 10 - protein, 8 aa, Artificial
  Artificial sequence for tyrosine bonding
QPGYYPTS

SEQ ID NO: 11 - protein, 23 aa, Triticum sp.
AEPPVARGLSFDFYRRTCPRAES

SEQ ID NO: 12 - protein, 359 aa, Hordeum vulgare
MARVPLLAALVVAMAVLVASSLGPRASAAEPPVAPGLSFDFYRRTCPRAESIVREFVQEAVRKDIGLAAGLLRLHFHDCFVQGCDASVLLDGSATGPGEQQAPPNLTLRPSAFKAVNDIRDRLERECRGAVVSCSDILALAARDSVVVSGGPDYRVPLGRRDSRSFASTQDVLSDLPGPSSNVQSLLALLGRLGLDATDLVTISGGHTIGLAHCSSFEDRLFPRPDPTISPTFLSRLKRTCPVKGTDRRTVLDVRTPNVFDNKYYIDLVNREGLFVSDQDLFTNAITRPIVERFARSQQDFFEQFGVSIGKMGQMRVRTSDQGEVRRNCSVRNPGPGADALQWPSLVQTIVDEAAGSIG

SEQ ID NO: 13 - protein, 28 aa, Hordeum vulgare
MARVPLLAALVVAMAVLVASSLGPRASA

SEQ ID NO: 14 - DNA, 1191 bp, AEGILOPS TAUSCHII
gtcacacacaaggagagaggagatggctcgtgctcctctgctagcagcacttgtggtggcggtggtagtggccagctcgcttgggcatggggcttctgcagcggagcctccggtggcgcgcggcctgtcgttcgacttctaccggcggacctgcccgcgggcggagtccatcgtgcgcggcttcgtccaggacgccgtgcgcaaggacatcggcctcgccgcaggcctcctccgcctccacttccacgactgcttcgtgcagggctgcgacgcctccgtgctcctcgacggctcggccacggggccaggggagcagcaggcgccgcccaacctcaccctccgcccctcggccttcaaggccgtcaacgacatccgcgaccggctggagcgcgagtgccgcggcgccgtcgtctcctgcgccgacatcctcgcgctcgccgcccgcgactccgtggtcgtctccggcgggcccgactaccgcgtgcctcttggccgccgtgacagccgcaggttcgccacgcggcaggacgtgctgtccgacctgccggcgccctcctcgaacgtgccgtccctcctcgccctgctccggcccctcggtctcgacgccaccgacctcgtcacgatctctggcggccacaccatcgggcaggcgcactgctccttcttcgaggaccggctcttccctcgtcccgaccccaccatcaaccccccattcctcgctaggctgaaggggacgtgccctgccaagggcaccgaccgacgcaccgtgctggacgtgcgcacgcccaacgtgttcgacaaccagtactatgtcgacctggtgaaccgggaggggctcttcgtctccgaccaggacctcttcaccaacgacatcacccggcccatcgttgagcgctttgcacgaagccagcgggacttcttcgagcagttcggcgtgtccatgggcaagatgggccagatgagggtgcgcaccagcgacctgggagaggtccgccggaactgctccgcccgcaaccccggcccagccgccgccgacgagctccagtggccgtcctttgtgcagaccatcgtcgatgcagctgcagaaaggcttggctagcttgtaagcatctagaccagtggactagtagctgttaatcatgtcgaaataataaaagtgaacaaacttgatatcaaaaaaaaaaaaaaaaa

SEQ ID NO: 15 - protein, 358 aa, AEGILOPS TAUSCHII
MARAPLLAALVVAVVVASSLGHGASAAEPPVARGLSFDFYRRTCPRAESIVRGFVQDAVRKDIGLAAGLLRLHFHDCFVQGCDASVLLDGSATGPGEQQAPPNLTLRPSAFKAVNDIRDRLERECRGAVVSCADILALAARDSVVVSGGPDYRVPLGRRDSRRFATRQDVLSDLPAPSSNVPSLLALLRPLGLDATDLVTISGGHTIGQAHCSSFEDRLFPRPDPTINPPFLARLKGTCPAKGTDRRTVLDVRTPNVFDNQYYVDLVNREGLFVSDQDLFTNDITRPIVERFARSQRDFFEQFGVSMGKMGQMRVRTSDLGEVRRNCSARNPGPAAADELQWPSFVQTIVDAAAERLG

SEQ ID NO: 16 - protein, 26 aa, AEGILOPS TAUSCHII
MARAPLLAALVVAVVVASSLGHGASA

(19) United States
(12) Patent Application Publication
(10) Pub. No.: US 2006/0172040 A1
(43) Pub. Date: Aug. 3, 2006

(54) Modification of dityrosine formation using enzymes and free radical scavengers

(76) Inventors: Katherine A. Tilley, Wamego, KS (US); Michael Tilley, Wamego, KS (US)

Correspondence Address: HOVEY WILLIAMS LLP, 2405 GRAND BLVD., SUITE 400, KANSAS CITY, MO, 64108, US

(21) Appl. No.: 10/464,795

(22) Filed: Jun. 17, 2003

(51) Int. Cl. A21D 13/00

(52) U.S. Cl. 426/94

(57) ABSTRACT

The present application affords control over tyrosine bonding in a variety of applications through the use of peroxidase enzymes, preferably wheat peroxidase 1, free radical scavengers, polyhydric alcohols, and protease. Methods of the present invention find utility in the bonding of polymers and proteins and are especially useful in the baking industry wherein the present invention will assist in consistently producing products of optimum quality.

### FEDERALLY SPONSORED RESEARCH OR DEVELOPMENT

This invention was made with government support of the USDA. The government has certain rights in the invention.

### SEQUENCE DISCLOSURE

A paper copy of the “Sequence Listing” is enclosed herein, and has also been submitted with identical contents in the form of a computer-readable ASCII file on CDROM. Each such listing is hereby incorporated by reference.

### BACKGROUND OF THE INVENTION

1. Field of the Invention

The present invention relates generally to catalyzation of polymeric structures wherein one or more polymers (either biopolymers such as proteins or synthetic polymers) are crosslinked by tyrosine bonds formed through peptides respectively associated with each polymer or polymer region, as well as isolated peptides useful in deriving such polymeric structures. The invention has particular applicability in the context of grains such as wheat, wherein the crosslinking property of grain protein can be altered by contacting the protein with an enzyme, preferably a peroxidase, or alcohol, preferably a polyhydric alcohol, and preferably mannitol, or ascorbic acid, or by genetically altering a gene within the grain which expresses the enzyme in order to cause the altered gene to express a greater or lesser number of enzymes and/or to produce enzymes with greater or lesser activity. Such alterations can result in a greater or lesser number of tyrosine bonds being formed.

The invention also is concerned with monitoring and assessing wheat or flour samples for dough forming potential, monitoring subsequent dough formation and modifying the physical properties of the dough during the course of dough mixing as well as end product formation. In practice, the levels of enzyme are measured in growing wheat and in flour to predict dough forming properties, based on the potential amount of enzyme available to catalyze the formation of tyrosine bonds produced during mixing of the flour with water to produce a dough. Measurements of the levels of tyrosine, dityrosine, phosphotyrosine, and other tyrosine bonded compounds may also be taken in growing wheat, flour and dough to further assess and predict dough forming properties and potential. The actual levels of tyrosine bonds formed in dough during mixing may also be monitored and manipulated as needed by the addition of enzyme and/or mannitol and/or ascorbic acid to consistently produce high quality doughs. Additionally, bonds incorporating tyrosine can be analyzed at different stages of end-product formation (e.g. baking) and manipulated as needed by the addition of enzyme or mannitol or ascorbic acid.

2. Description of the Prior Art

In flour dough manufacture, dough is produced by mixing wheat flour and water. Other ingredients (e.g. salt) are added depending on the product being made. Dough made from wheat flour has a viscoelastic property not exhibited by doughs made from other cereals. This viscoelastic property is believed to be derived from gluten protein. The glutenin subunits, one of the two classes of storage proteins which are part of the gluten complex in wheat, are known to directly affect dough formation and bread making quality. In the past, theories regarding dough formation were developed with the idea that only disulfide crosslinks are involved in the mechanism of gluten structure formation. It was believed that these disulfide bonds were formed and/or broken and reformed during the mixing process and were ultimately responsible for the characteristics exhibited by a particular sample of dough.

Recently, it has been shown that a class of tyrosine-containing peptides form tyrosine bonds (as defined herein) in the protein fraction of wheat, wheat flour, wheat doughs and final products derived from such doughs, and that such tyrosine bonds have a profound effect upon final product quality. Knowledge of the effect of tyrosine bonds on dough formation and end product quality has enabled the testing of wheat during growth thereof to determine the tyrosine bond level therein and to alter if necessary the growth conditions of the wheat so as to change the tyrosine bond level in the final harvested wheat protein. By the same token, it was shown that tyrosine bond levels could be measured in flour so as to permit a baker to adjust formulation or baking conditions for optimum results. More fundamentally, wheat may be genetically altered using known techniques such as site directed mutagenesis in order to increase or decrease the level of tyrosine available for tyrosine bond formation.

Based on the intended use of the dough, different properties may be desired, i.e., a dough intended to be used for bread may have different desirable properties than a dough made for breakfast cereal processing. Additionally, similar flours used in dough processing may exhibit different characteristics during mixing due to environmental conditions present when the grain used to make the flour was growing or genetic differences. Moreover, some varieties of wheat are less effected by specific environmental conditions than other varieties.

The addition of oxidizing/reducing agents, free radical scavengers, metal chelating agents, or adjusting dough pH during processing has been proposed to affect the properties and consistency of the dough as desired. For example, a common modifier and improver of doughs, potassium bromate (KBrO₃) is known to have positive effects on dough quality. Due to KBrO₃'s dough improving effects, it was a common ingredient in most dough formulas. Unfortunately, KBrO₃ has been determined to be potentially carcinogenic at certain levels and its use in bread doughs has been banned in the United Kingdom, Japan and New Zealand. The United States has limited the use of KBrO₃ with maximum permitted levels of 50 or 75 ppm. However, following a request from the FDA in 1991, a majority of baking companies have voluntarily stopped using KBrO₃.

As a result of processing, dough can become sticky and reduce operating efficiency causing expensive delays and product loss. Alternatively, the dough can be overdeveloped or overworked resulting in low quality products. There is a point in time during mixing of every dough where continued mixing beyond that point results in a dough of inferior quality. Stopping the mixing process prior to that point also results in unacceptable dough quality.

With regard to processing effects, the native wheat enzymes of primary interest have been oxidases (specifically lipoxygenases and peroxidases) and catalase. Lipoxygenases are thought to increase mixing tolerance and relaxation times of dough, ultimately leading to increased bread loaf volume.

Peroxidase and catalase functionality in flour has not been thoroughly characterized, although there is a high level of activity of both enzymes in flour. It has previously been claimed that the addition of horseradish peroxidase has an improving effect on baking properties. Peroxidase, in the presence of hydrogen peroxide, appears to be the most efficient catalyst for the oxidative gelation of wheat flour water-soluble pentosans. The mechanisms for oxidative crosslinking of pentosans include formation of a diferulate bridge thereby crosslinking adjacent arabinoxylan chains and addition of a protein radical to the activated double bond of a ferulic acid esterified to the arabinoxylan fraction, resulting in crosslinking a protein and pentosan chain.

The addition of glucose oxidase to flour also results in an improvement in dough properties. This could be due to hydrogen peroxide formation, through the oxidation of glucose, leading to the activation of peroxidase and catalase. However, the effective action of peroxidase and catalase in breadmaking is uncertain because the formation of hydrogen peroxide, their primary substrate, during dough mixing remains questionable.

The activity of native lipoxygenase, peroxidase, and catalase extracted from dough after 2, 5, and 20 minutes of mixing and 30 minutes of rest period after 20 minutes of mixing has been examined. In all mixing conditions tested, the dough peroxidase activity remained equivalent to the initial flour activity, whereas losses in lipoxygenase and catalase activities largely varied according to mixing conditions. This maybe of importance when considering the fact that some oxidoreducing enzymes such as glucose oxidase and sulfhydryl oxidase have been proposed as improvers for the baking industry. One potential conclusion was that the improving mechanism was due to the formation of H₂O₂ during catalysis, which could then be used by peroxidase to promote crosslinking between pentosans and protein chains.

Tyrosine bond formation can occur in biological systems via enzymatic initiation and the subsequent formation of H₂O₂. Tyrosine crosslinks have also been enzymatically catalyzed in vitro using horseradish peroxidase. In addition, researchers have been able to obtain “enzyme-assisted” oxidative polymerization of wheat gliadins using soybean and horseradish peroxidase.

It has not yet been shown whether the unusually stable native peroxidase activity that exists in dough, even after 20 minutes of mixing, causes formation of tyrosine crosslinks in gluten.

Research has also shown that during imbibition and germination of wheat over 72 hours, activities of the enzymes of the ascorbate (AsA)-dependent H₂O₂ scavenging pathway, AsA peroxidase, monodehydroascorbate reductase, dehydroascorbate reductase and glutathione reductase, as well as superoxide dismutase, catalase and guaiacol peroxidase increase in both whole grains and endosperm. The biological purpose for the increase in these enzymes is not yet understood. A role of peroxidases in phenolic metabolism in durum wheat has been detected and researchers have noted progressive changes from ester-linked forms of ferulic acid and ρ-coumaric acid in kernels in early stages of development to their insoluble derivatives in the fully mature kernel.

While a clear explanation of their function has not been deciphered, peroxidase enzymes have been detected in wheat endosperm (flour) and are predicted to play various roles during germination of the kernel. Several cationic peroxidase isoenzymes have been identified in wheat germ, and these enzymes were shown to increase during water imbibition and germination. Native enzymes contained in the endosperm of wheat apparently have various biological functions in the wheat plant, although those functions have not been clearly delineated. In addition, it appears possible that some of these enzymes, particularly the peroxidases, which remain active during the mixing process, may cause tyrosine crosslink formation between and among the gluten proteins as a result of their increased random activity in the dough when water is added to the flour and the mixing process is carried out.

What is needed are methods of: monitoring and assessing dough forming potential in developing wheat kernels; controlling tyrosine bonding in grain and non-grain settings; genetically altering wheat cultivars to modify dough forming potential; methods of making wheat-like doughs using other grains; precalibrating processing equipment based on the amount of enzyme present thereby reducing the amount of manipulation required to efficiently produce an optimum dough; determining the quality of grain seeds, flour, and/or dough, based on the amount of enzyme that catalyzes the formation of tyrosine bonds; monitoring dough formation during processing so as to assess dough characteristics in a way that consistently results in product optimization; manipulating dough formation during processing to effect optimization of the final dough product; altering the amount of enzyme in grain seeds, flour, and/or dough; modifying physical characteristics of polymers including synthetic polymers as well as biopolymers; altering the amount of tyrosine bonds formed during dough manufacture and further processing; substantially preventing further formation of tyrosine bonds; and increasing or decreasing the rate at which tyrosine bonds are formed during the mixing process as well as during further dough processing. Finally, what is needed is an enzyme and the DNA sequence coding for an enzyme which catalyzes tyrosine bond formation.

### SUMMARY OF THE INVENTION

The ability of a given wheat, or flour derived from that wheat, to form gluten determines its utilization quality. Wheat breeding technology, from the traditional plant crossing techniques to the more recent molecular breeding techniques, are focused upon the improvement of wheat's gluten forming properties. Although numerous studies have been conducted, full comprehension of the molecular associations and covalent bond formation in dough during mixing has not been realized. The mechanisms by which wheat plants deposit storage proteins as well as carbohydrates are extremely complex.

The storage material (endosperm) within a kernel is designed for utilization by the developing embryonic plant as the seed spouts. However, mankind has been exploiting the storage material of wheat kernels for an unrelated purpose, the production of wheat dough based food products. The storage material found in the wheat kernel (endosperm) is processed into flour, and flour is used to develop a viscoelastic dough. Contained in that dough are all the components that comprise the endosperm; namely, storage proteins, carbohydrates, lipids and enzymes. These compounds interact to form dough and to eventually form the final dough-based product.

One of the most important aspects of these interactions is the manner in which the gluten proteins interact to form the scaffolding structure around which dough forms. A complete understanding of the molecular mechanisms by which gluten proteins interact and dough forms is crucial in the agriculture industry and represents a phenomenon of worldwide importance with vast economic impact. Wheat is a major commodity in world agriculture. The ability to understand ways in which gluten proteins can be modified to fit various specifications represents a revolution in applications that range from the food to the non-food industry.

As noted above, it has recently been shown that tyrosine crosslinks are directly responsible for dough formation and provide the molecular basis for bread formation. The enzymes that were of interest to researchers studying disulfide bonds are also capable of affecting tyrosine crosslinks during dough formation. These enzymes, especially those naturally occurring in the wheat kernel endosperm, were of specific interest because they are the enzymes that catalyze gluten structure formation in a simple flour and water dough and underlie the mystery of the unique dough forming capabilities of wheat. Until now, these native enzymes have never been isolated and characterized in relation to tyrosine crosslink formation and its relevance to dough/bread making quality.

I. General Aspects of the Invention

As used herein, the following definitions will apply: “Tyrosine” refers to the tyrosine residues within a peptide or protein chain. “Tyrosine bonds” in the context of plant proteins refers to bonds between a tyrosine residue within a peptide or protein chain and another chemical moiety, free or within a polypeptide, and embraces dityrosine species as well as multiple bonds between respective tyrosine residues and a common bridging moiety. More generally, “tyrosine bonds” refers to bonds other than peptide bonds formed by two peptides, each peptide including therein at least one tyrosine residue and often including a tyrosine pair made up of two peptide-bonded tyrosine residues. These bond forming peptides may be a part of a protein or coupled to a protein, another biopolymer, or a synthetic polymer. “Dityrosine species” embrace dityrosine, isodityrosine, trityrosine, di-isodityrosine, and analogs thereof. “Free tyrosine” refers to the amino acid tyrosine when not within a peptide or protein chain. “Tyrosine pair” refers to two peptide bonded tyrosine residues (YY), either alone or in a larger amino acid sequence. “Dityrosine” refers to two tyrosine residues linked together by biphenyl or ether linkages. “Dityrosine analytical reference standard” refers to two tyrosine moieties linked through a biphenyl linkage and having the following structure.

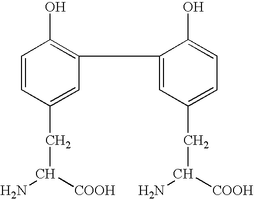

“Optimum” with respect to a dough's viscoelastic properties refers to when a dough exhibits desired physical characteristics based on the dough's eventual end-use taking into account the fact that doughs having different eventual end-uses may have different desired viscoelastic characteristics. “Analysis” with respect to tyrosine, dityrosine or phosphotyrosine content refers to any technique for determining tyrosine, dityrosine, phosphotyrosine and/or tyrosine bond content such as amino acid analysis of protein or protein hydrolysates, elucidation and analysis of appropriate nucleic acid sequences, and any other physical analytical methods (e.g. NMR). “Isolated” means altered “by the hand of man” from its natural state., i.e., if it occurs in nature, it has been changed or removed from its original environment, or both. For example, a polynucleotide or polypeptide naturally present in a living organism is not “isolated,” but the same polynucleotide or polypeptide separated from the coexisting materials of its natural state is “isolated”, as the term is employed herein. A “reversal” of a peptide refers to a reverse-order amino acid sequence between the amino and carboxyl ends of a given peptide. For example, in the case of QQGYYPTS, its reversal would be STPYYGQQ.

As used herein, the following definitions will apply: “Sequence Identity” as it is known in the art refers to a relationship between two or more polypeptide sequences or two or more polynucleotide sequences, namely a reference sequence and a given sequence to be compared with the reference sequence. Sequence identity is determined by comparing the given sequence to the reference sequence after the sequences have been optimally aligned to produce the highest degree of sequence similarity, as determined by the match between strings of such sequences. Upon such alignment, sequence identity is ascertained on a position-by-position basis, e.g., the sequences are “identical” at a particular position if at that position, the nucleotides or amino acid residues are identical. The total number of such position identities is then divided by the total number of nucleotides or residues in the reference sequence to give % sequence identity. Sequence identity can be readily calculated by known methods, including but not limited to, those described in Computational Molecular Biology, Lesk, A. N., ed., Oxford University Press, New York (1988), Biocomputing: Informatics and Genome Projects, Smith, D. W., ed., Academic Press, New York (1993); Computer Analysis of Sequence Data, Part I, Griffin, A. M., and Griffin, H. G., eds., Humana Press, New Jersey (1994); Sequence Analysis in Molecular Biology, von Heinge, G., Academic Press (1987); Sequence Analysis Primer, Gribskov, M. and Devereux, J., eds., M. Stockton Press, New York (1991); and Carillo, H., and Lipman, D., SIAM J. Applied Math., 48: 1073 (1988), the teachings of which are incorporated herein by reference. Preferred methods to determine the sequence identity are designed to give the largest match between the sequences tested. Methods to determine sequence identity are codified in publicly available computer programs which determine sequence identity between given sequences. Examples of such programs include, but are not limited to, the GCG program package (Devereux, J., et al., Nucleic Acids Research, 12(1):387 (1984)), BLASTP, BLASTN and FASTA (Altschul, S. F. et al., J. Molec. Biol., 215:403-410 (1990). The BLASTX program is publicly available from NCBI and other sources (BLAST Manual, Altschul, S. et al., NCVI NLM NIH Bethesda, Md. 20894, Altschul, S. F. et al., J. Molec. Biol., 215:403-410 (1990), the teachings of which are incorporated herein by reference). These programs optimally align sequences using default gap weights in order to produce the highest level of sequence identity between the given and reference sequences. As an illustration, by a polynucleotide having a nucleotide sequence having at least, for example, 95% “sequence identity” to a reference nucleotide sequence, it is intended that the nucleotide sequence of the given polynucleotide is identical to the reference sequence except that the given polynucleotide sequence may include up to 5 point mutations per each 100 nucleotides of the reference nucleotide sequence. In other words, in a polynucleotide having a nucleotide sequence having at least 95% identity relative to the reference nucleotide sequence, up to 5% of the nucleotides in the reference sequence may be deleted or substituted with another nucleotide, or a number of nucleotides up to 5% of the total nucleotides in the reference sequence may be inserted into the reference sequence. These mutations of the reference sequence may occur at the 5′ or 3′ terminal positions of the reference nucleotide sequence or anywhere between those terminal positions, interspersed either individually among nucleotides in the reference sequence or in one or more contiguous groups within the reference sequence. Analogously, by a polypeptide having a given amino acid sequence having at least, for example, 95% sequence identity to a reference amino acid sequence, it is intended that the given amino acid sequence of the polypeptide is identical to the reference sequence except that the given polypeptide sequence may include up to 5 amino acid alterations per each 100 amino acids of the reference amino acid sequence. In other words, to obtain a given polypeptide sequence having at least 95% sequence identity with a reference amino acid sequence, up to 5% of the amino acid residues in the reference sequence may be deleted or substituted with another amino acid, or a number of amino acids up to 5% of the total number of amino acid residues in the reference sequence may be inserted into the reference sequence. These alterations of the reference sequence may occur at the amino or the carboxy terminal positions of the reference amino acid sequence or anywhere between those terminal positions, interspersed either individually among residues in the reference sequence or in the one or more contiguous groups within the reference sequence. Preferably, residue positions which are not identical differ by conservative amino acid substitutions. However, conservative substitutions are not included as a match when determining sequence identity.

Similarly, “sequence homology”, as used herein, also refers to a method of determining the relatedness of two sequences. To determine sequence homology, two or more sequences are optimally aligned as described above, and gaps are introduced if necessary. However, in contrast to “sequence identity”, conservative amino acid substitutions are counted as a match when determining sequence homology. In other words, to obtain a polypeptide or polynucleotide having 95% sequence homology with a reference sequence, 95% of the amino acid residues or nucleotides in the reference sequence must match or comprise a conservative substitution with another amino acid or nucleotide, or a number of amino acids or nucleotides up to 5% of the total amino acid residues or nucleotides, not including conservative substitutions, in the reference sequence may be inserted into the reference sequence.

Another alternative method of determining homology is the Lipman-Pearson protein alignment method of the Lasergene software, DNASTAR Inc., Madison, Wis.

A “conservative substitution” refers to the substitution of an amino acid residue or nucleotide with another amino acid residue or nucleotide having similar characteristics or properties including size, hydrophobicity, etc., such that the overall functionality does not change significantly.

The present invention is predicated upon the discovery of a native wheat enzyme that catalyzes the formation of tyrosine bonds during dough formation and the bread making processes as well as the discovery that mannitol, xylitol, sorbitol, and glycerol prevent or reduce the formation of tyrosine bonds. These discoveries permit control of the tyrosine bonding process in dough and non-dough products.

One aspect of the present invention is the testing of wheat during growth thereof to determine the amount of enzyme that will be produced and to alter if necessary the growth conditions of the wheat so as to change the amount of enzyme in the final harvested wheat protein. By the same token, enzyme amounts can be measured in flour so as to permit a baker to adjust formulation or baking conditions for optimum results. More fundamentally, wheat may be genetically altered using known techniques such as site directed mutagenesis in order to increase or decrease the level of enzyme.

Another aspect of the present invention is that the knowledge of the enzyme's effect on tyrosine bonding in wheat and the effect thereof on dough and product quality, permits alteration of other grain products (e.g., corn and soy) which do not form wheat-like doughs to incorporate tyrosine bonds into the grain protein thereof and to catalyze the formation of tyrosine bonds during the making of doughs from these non-wheat products. Accordingly, other grains may be genetically altered or otherwise treated to exhibit desired levels of enzyme and/or tyrosine in the protein fraction thereof so as to catalyze an optimum amount of tyrosine bonds and make a wheat-like dough.

Still further, this knowledge allows and controls the use of tyrosine bond-forming peptides in a wide variety of contexts beyond plant proteins. For example, use of the enzyme or mannitol, xylitol, sorbitol, or glycerol may effect isolated peptide crosslinkers which can crosslink with polymers (either intrapolymer or interpolymer) to yield new non-naturally occuring polymers and composite polymeric structures. Such effects include controlling the rate of formation of these peptide crosslinkers and controlling the amount of crosslinks that can be formed with these peptides. Thus, the enzyme or mannitol, xylitol, sorbitol, or glycerol may be used to effect isolated peptides that can be used as such crosslinkers wherein the peptides are selected from the group consisting of: (1) peptides having the sequence XₐYYX_{b} (SEQ ID No. 1); (2) peptides having the sequence XₐQXGXYPTSX_{b} (SEQ ID No. 2); (3) peptides having the sequence XₐQXGYXPTSX_{b} (SEQ ID No. 3); (4) peptides having the sequence XₐGQGQXGXYPTSXQQX_{b} (SEQ ID No. 4); (5) peptides having the sequence XₐGQGQXGYXPTSXQQX_{b} (SEQ ID No. 5), and (6) reversals of all of the foregoing, wherein each X independently represents any amino acid residue, and the sum of a+b ranges from 0-14. Particularly preferred isolated peptides include YY (i.e., a tyrosine pair), and QQGYYPTS or QPGYYPTS.

The invention thus includes controlling the formation of non-naturally occurring polymers made up of a polymer chain with one or more of the foregoing peptides within or attached to the polymer chain. The class of polymers susceptible to control is extremely broad, and embraces biopolymers (e.g., proteins, polysaccharides, starches, nucleic acids, lipids) as well as the synthetic polymers described herein. Thus, any naturally occurring wheat or other plant protein made by being modified to include therein the peptide(s), either within the normal protein sequence or as a side chain or end cap to the protein can be effected by the use of the enzyme or mannitol, xylitol, sorbitol, or glycerol. Similarly, control may be had over the formation of synthetic polymers and composite polymers that are modified with the above-mentioned peptide(s) as internal, side chain, or end cap substituents.

One class of polymeric structures that may be catalyzed or effected in accordance with the invention includes a pair of discrete naturally occurring biopolymers (e.g., proteins including enzymes, plant proteins, plant storage proteins) coupled together through one or more tyrosine bonds, typically forming ditytosine. The biopolymers in the composite polymeric structure may be the same or different. However, in all cases the tyrosine bond(s) are formed by two peptides respectively associated with each of the discrete biopolymers, and with at least one of the peptides being non-naturally occurring with respect to the corresponding biopolymer. As indicated above, each of the bond-forming peptides individually has from 2 to about 28 amino acid residues therein and including a tyrosine residue; in many cases, the peptides include a tyrosine pair, the latter being made up of two peptide-bonded tyrosine residues. As indicated, the peptides are associated with each biopolymer. In the case of protein biopolymers, the peptide may be within and form a part of the sequence of the protein, or alternately may be attached as a side chain or terminal group on the protein. If necessary or desirable, the bond-forming peptides may be coupled to the corresponding biopolymers through conventional coupling agents.

It is contemplated that the non-naturally occurring biopolymers and crosslinked biopolymer polymeric structures in accordance with the invention will usually be made up of biopolymers selected from the group consisting of plant proteins, such as storage proteins from grains such as amaranth (Amaranthus hypochondiacus=A. leucocarpus, Amaranthus caudatus, Amaranthus cruentus), barley (Hordeum vulgare), malting barley, buckwheat (kasha) (Fagpyrum esculentum), canary seed (Phalaris canariensis), false melic grass (Schizachne purpurascens), maize (Zea mays), millet, common millet, (Panicum miliaceum), red millet, (Eleusine coracana), bulrush millet (Pennisetum typhoideum), foxtail millet (Setaria italica), proso millet (Panicum miliaceum), finger millet (Eleusine coracana), pearl millet, bulrush millet, cattail millet (Pennisetum glaucum), fonio millet (Digitaria exilis), oats (Avena sativa), quinoa chenopodium spp quinoa (Chenopodium quinoa), rice (Oryza sativa), wild rice (Zizania palustris), rye (Secale cereale), sorghum (Sorghum bicolor), and kamut; wheat and wheat relatives such as Triticum aestivum, Triticum spp., triticale, Triticum monococcum (Einkorn), khorasan, Triticum boeticum, Triticum, monococcum, Triticum dicoccoides (Emmer), Aegilops speltoides, Aegilops squarrosa, Triticum durum (durum), Triticum turgidum (rivet), Triticum turanicum (Khorasan), Triticum polonicum (Polish), Triticum carthlicum (Persian), Triticum aestivum, Triticum aestivum spelta (Spelt), Triticum aestivum macha (Macha), Triticum aestivum vavilova (Vavlilovi), Triticum aestivum tibetanum (soft winter wheat), Triticum aestivum vulgare (common wheat), Triticum aestivum compactum (Club), and Triticum aestivum sphaerococcum (Shot); oilseeds such as canola (Brassica napus), flaxseed (Linum usitatissimum), mustard (Brassica juncea), safflower (Carthamus tinctoris), sunflower (Helianthus annuus), soybean (Glycine max), crambe (Crambe abyssinica), and meadowfoam (Linanthes alba); pulses such as adzuki bean (Vigna angularis), anasazi, baby white lima, black beans (turtle), cranberry bean, kidney bean, European soldier, fava, flageollettes, Great Northern, Jacobs cattle, lupini, navy, pinto, prim manteca, rattlesnake, small red, snow cap, white kidney (cannelloni), phaseolus spp., vigna spp., chickpea (Cicer arietinum), common bean (Phaseolus vulgaris), faba bean (Vicia faba), grass pea (Lathyrus sativus), lentil (Lens culinaris), mung bean (Vigna radiata), pea (Pisum sativum) and guar plant (Cyampopsis tetragonolobus); legumes such as alfalfa (Medicago sativa), lupin (Lupinus albus), cicer milkvetch (Astragalus cicer), crownvetch (Coronilla varia), and fenugreek (Trigonella foenum-graecum); tubers such as potato (Solanum tuberosum), cassava, manioc, taro (Colocasia esculenta), yam, sweet potato and konjac; as well as the proteins in other plants of uncertain affiliation including psyllium (Plantago ovata), carob (Ceratonia siliqua), sweet chestnut (Castanea sativa), teff, Eragrostis abyssinica (Eragrostis tef), arrowroot, cowpea, almond, peanut, milkweed, sesame (Sesamum indicum), euphorbia (Euphorbia lagascae), fennel (Foeniculum vulgare), gumweed (Grindelia camporum), field peas, horsebean, tapioca, banana, plantain, peas, seaweed, and kelp. Other suitable biopolymers include flax (genus Linum), cotton (genus Gossypium), industrial hemp (Cannabis sativa), wool (sheep fiber), wood (tree fiber), silk (produced by silkworm (moth) larvae Bombyx mori), mohair (Merino sheep, angora goats), cashmere (goats), jute (Corchorus capsularis or C. olitorius), kanaf (Hibiscus cannabinus), sugarcane (Saccharum officinarum), and sorghum (Sorghum vulgare). Accordingly, control over tyrosine bonding in each of these storage proteins is possible using methods of the present invention.

Another polymeric structure that can be controlled through methods in accordance with the present invention can be made up of only a single naturally occurring biopolymer or synthetic polymer having respective portions thereof coupled together through one or more tyrosine bonds. In this case, the tyrosine bonds are also formed by two peptides respectively associated with the biopolymer or synthetic polymer portions, and with at least one of said peptides being non-naturally occurring with respect to the biopolymer or synthetic polymer. This type of polymeric structure would be possible with relatively large proteins or the like having a conformation permitting portions thereof to come into close adjacency for tyrosine bond formation. Examples of such single biopolymers include enzymes, such as saccharifying enzymes, gluconase, carbohydrase, glucoamylase, protease, pectinase, mannase, urease, cellulase, pentosanase, xylanase, lysozyme, catalase, invertase, isomerase, lipase, hydolase, deaminase, phosphatase, dehydrogenase, oxidase, esterase, lyase, aminoacylase, amyloglucosidase, peroxidase, aspartase, galactosidase, catalase, lactase, debranching enzyme, alcalase, nuclease, polyphenoloxidase, carboxyl peptidase, cellulase, crosslinking enzymes, dehydrogenase, dextranase, diastase, peptidase, peutosanases, metal loprotease, elastase, fatty acid synthetase, hydrolase, demethylase, kinase, β-galactosidase, thermolysin, phosphoglucomutase, synthase, deaminase, pectase, plasmin, renin, polygalachinonase, pullulanase, phosphodiesterase, subtilisin, transferase, and lysozyme.

As indicated above, the invention also includes control over the formation of polymers and composite polymeric structures made up of synthetic polymers having the peptides hereof within the polymeric chain or attached thereto, or in the case of composites plural polymers coupled together through one or more tyrosine bonds. Here again, the tyrosine bonds are formed by two peptides associated with the discrete synthetic polymers, those peptides being the same as the peptide sequences defined previously. Synthetic polymers useful with these methods of the invention include polymers containing primary and secondary hydroxyl, primary and secondary amino, carboxyl and isocyanate groups. Examples of suitable polymers would be the C₂-C₄ polyalkylene glycols (e.g., the polyethylene glycols) and aminated and carboxy-capped derivatives thereof, polysaccharides and their carboxylated and aminated derivatives, the polyacrylates (e.g., polymethylmethacrylate) and derivatives thereof, and the polystyrene, polyethylene and polypropylene copolymers containing hydroxyl, amino or carboxyl functional groups. Also, the peptides may be attached to the individual synthetic polymers in any fashion, such as a side chain or terminal group. These peptide crosslinkers would typically be attached to the synthetic polymers via known coupling agents.

As indicated previously, one important aspect of the invention involves the genetic manipulation of specific plant genes in order to introduce or alter the level of enzyme-forming subunits in proteins expressed by those genes. Of course, wheat is a prime candidate for such genetic manipulation, inasmuch as wheats inherently have such enzyme-forming subunits as well as the bond-forming subunits effected by these enzymes in the protein fractions thereof. However, other plants such as those listed above and especially including wheat, soy, corn, rye, oats, triticale, sorghum, rice, and barley can be altered in this manner. Such altered plants can then be used to form wheat-like doughs having the stickiness, viscoelastic and structural properties similar to that of traditional wheat doughs. In this respect, it may be helpful to further genetically manipulate the level of tyrosine bond forming subunits expressed by genes of plants. It will thus be appreciated that, broadly speaking, the invention provides a method of controlling a crosslinking property of a protein by genetically altering a gene which expresses the protein in order to cause the altered gene to express a protein having a greater or lesser number of enzyme-forming and/or tyrosine bond forming subunits therein, as compared with the naturally occurring gene, or that the enzyme-forming subunits and/or the tyrosine bond forming subunits have greater or lesser activity as compared with those resulting from the naturally occurring gene.

In the case of a genetic manipulation of a plant protein gene to introduce codons which will express such altered enzyme-forming subunits in the protein, use may be made of conventional gene engineering methods. In the case of wheat, it would normally be preferred to insert the codon sequence found in wheat glutenin genes and which codes for the WP 1 enzyme, namely SEQ ID No. 6, into the selected genes, or to mutate such genes to achieve this sequence. However, owing to the degeneracy of the genetic code, other codons coding for the desired amino acid residues may be employed. Thus, glutamine could be coded for using the codon sequence caa, cag; glycine could be coded for using the codon sequence ggt, ggc, gga, ggg; tyrosine could be coded for using the codon sequence tat or tac; proline could be coded for using the codon sequence cct, ccc, cca, or ccg; threonine could be coded for using the codon sequence act, acc, aca, or acg; and serine could be coded for using the codon sequence agt, agc, tct, tcc, tca, or tcg. Other specific insertions or mutations would of course be subject to the same analysis. Furthermore, other peroxidase enzyme codon sequences could also be genetically engineered into selected genes in order to practice methods of the present invention.

The invention also comprehends a method of growing a plant having genes in the genome thereof which express proteins including the following enzymes: NADH₂ peroxidase fatty-acid peroxidase, tryptophan 2,3-dioxygenase, cytochrome-c peroxidase, catalase, peroxidase, iodide peroxidase, glutathione peroxidase, chloride peroxidase, L-ascorbate peroxidase, phospholipid-hydroperoxide glutathione peroxidase, manganese peroxidase, diarylpropane peroxidase, and sequences which include the sequence of SEQ ID No. 7, which is the protein expressed by WP 1. For example, naturally occurring wheat or genetically altered grains described previously are embraced within the applicable plants. The method comprises the steps of periodically analyzing the plant or plant structure during growth thereof to determine the level of enzyme forming subunits therein. Additionally, the method may involve assessing the level of tyrosine bond-forming subunits therein.

When production of the enzyme is necessary, conventional methods of protein expression can be used. One such method would insert the gene for the enzyme in yeast, bacteria or other organisms used in processing and rely on them to produce the enzyme over time during processing. For example if a flour made a weak dough and a stronger dough was needed for breadmaking, one could add a yeast strain that produces “x” amount of yeast over “y” amount of time. There can be different strains with varying levels of ability to produce various levels of enzyme and at different times in processing.

In all of these aspects, it will be appreciated that free radical scavengers such as mannitol, sorbitol, xylitol, glycerol, or ascorbic acid may be used to prevent further bonding of tyrosine and formation of tyrosine bonds. The free radical scavengers scavenge the free tyrosyl radicals formed by the peroxidase enzyme, thereby preventing crosslink formation. In use, crosslink formation will be monitored and when desired levels of bonding/crosslinking are reached, a free radical scavenger such as mannitol or ascorbic acid will be added in an amount sufficient to prevent further bonding or crosslinking of tyrosine. Alternatively, the free radical scavenger may be added after a certain amount of time or it may be released (as through an encapsulation process) upon the occurrence of a certain condition (e.g. hydration, pH, time, temperature, etc.). Any conventional encapsulation process may be used including those taught by Chaize, B. Encapsulation of Acetylcholinesterase in Preformed Liposomes, 34 BioTechniques, 1158-1162 (2003); Lloyd, C. and Eyring, E., Protecting Heme Enzyme Peroxidase Activity from H₂O₂ Inactivation by Sol-Gel Encapsulation, 16 Langmuir, 9092-9094 (2000); and Dulieu, C. et al., Improved Performances and Control of Beer Fermentation Using Encapsulated α-Acetolactate Decarboxylase and Modeling, 16 Biotechnol. Prog., 958-965 (2000) (the content and teachings of which are hereby incorporated by reference herein).

II. Wheat Aspects of the Invention

As indicated above, the invention has particular applicability in the context of wheat, wheat flour, wheat doughs and final wheat-based products, and provides techniques for optimizing the foregoing. For example, through use of the methods of the present invention, wheat kernels can be grown which form high quality flours and consistently result in optimum flour dough product preparation despite differences in initial flour quality, environmental stresses which occurred during wheat kernel development, genetic differences or mixing times, all of which previously resulted in doughs of dramatically different quality. Overall quality control in wheat development and dough processing can be more tightly controlled through use of the methods of the present invention.

The preferred dough monitoring method includes preparing a dough in the normal fashion and monitoring active enzyme levels. The method may further include the steps of monitoring the rate of formation or the level of formation of tyrosine, dityrosine and phosphotyrosine. The methods of the present invention permit control over the binding of tyrosine residues and their ability to bond and/or form crosslinks between and among other chemical residues or moieties, e.g., tyrosine residues, quinones, hydroquinone, dihydroxyphenylalanine (DOPA), dopaquinone, semiquinones, glutathione (GSH), cysteine, catechols and various carbohydrates. Some of these compounds may also act as a bridge between tyrosine residues in proteins. Structures including tyrosine residues include dityrosine, isodityrosine, trityrosine and other potential structures involving covalent bonds between and among tyrosine residues as well as crosslinks between tyrosine residues and other compounds. Typical tyrosine-bonded chemical moieties found in flours or doughs may include other tyrosine residues, quinones, hydroquinone, dihydroxyphenylalanine (DOPA), dopaquinone, semiquinones, glutathione (GSH), cysteine, catechols and various carbohydrates as well as other structures which could form tyrosine bonds. However, the most significant tyrosine-bonded moieties consist of tyrosine residues bound to other tyrosine residues through a bonding mechanism other than peptide bonding and the methods of the present invention permit control over this bonding mechanism.

For any given process, predetermined standards for an optimum range of enzyme forming subunits and their effect on tyrosine bonding will govern the monitoring and any subsequent modification of tyrosine formation in the dough. The monitoring provides continuous feedback indicating the approximate range or levels of enzyme forming subunits as well as tyrosine bonds at individual stages in the process. If there are too many tyrosine bonds, this information is used for example to direct the addition of a specific amount of an alcohol, preferably mannitol, xylitol, sorbitol, or glycerol or ascorbic acid which effect the tyrosyl radicals (which form the tyrosine crosslinks) produced by the peroxidase enzyme. In some cases, the alcohol is added in combination with at least one other ingredient selected from the group consisting of the amino acid tyrosine, a tyrosine analog, free radical scavengers or metal chelating agents, to the dough to prevent over-formation of tyrosine bonds. If this factor is not monitored and alcohol and/or alcohol with at least one other ingredient is not added, continued mixing will cause the dough to become too sticky resulting in reduced processing efficiency. The present invention also allows for mixing to progress past the point in time at which, the dough has an optimum number of tyrosine bonds and the dough exhibits desired viscoelastic properties. If alcohol is added to the dough once an optimum range of tyrosine bonds is reached, mixing may continue without a significant subsequent increase in the number of tyrosine bonds and corresponding loss of desired viscoelastic properties. This occurs due to the scavenging of the tyrosyl radical by the alcohol. With a reduced number of tyrosyl radicals available for tyrosine bond formation, tyrosine bonding decreases or stops altogether. Thus, mixing may continue without a significant corresponding increase in tyrosine bonds and loss of desired viscoelastic properties. Preferably, mixing may continue for up to about 10 minutes after reaching the optimum range of tyrosine bonds while retaining ±10% of the desired viscoelastic properties. More preferably, mixing may continue for up to about 20 minutes after reaching the optimum range of tyrosine bonds while retaining ±10% of the desired viscoelastic properties. Still more preferably, mixing may continue for up to about 10 minutes after reaching the optimum range of tyrosine bonds while retaining ±20% of the desired viscoelastic properties. Even more preferably, mixing may continue for up to about 20 minutes while maintaining ±20% of the desired viscoelastic properties. Increasing the pH of the dough will also result in a decrease in the rate of dough formation and may decrease the rate of tyrosine bond formation.

Conversely, if there are not enough tyrosine bonds formed at a given stage of the mixing process, enzyme may be added in order to catalyze the rate of tyrosine bond formation. Preferably, the enzyme is a peroxidase, still more preferably, the enzyme is selected from the group consisting of NADH₂ peroxidase fatty-acid peroxidase, tryptophan 2,3-dioxygenase, cytochrome-c peroxidase, catalase, peroxidase, iodide peroxidase, glutathione peroxidase, chloride peroxidase, L-ascorbate peroxidase, phospholipid-hydroperoxide glutathione peroxidase, manganese peroxidase, diarylpropane peroxidase, WP 1, and sequences which include the sequence of SEQ ID No. 7. Addition of enzyme to a dough which is not forming enough tyrosine bonds at a given stage in the process will increase dough quality by causing development of necessary viscoelastic properties through the catalyzation of tyrosine bonds. Additionally, decreasing the pH of dough during processing will also affect dough characteristics and may promote tyrosine bond formation.

The preferred method would also include using a computer program configured to achieve a predetermined range of active enzyme and/or tyrosine bonds in a dough by directing the manipulation and/or addition of additives to the dough during mixing. These steps would be carried out manually or automatically in response to the approximate amount of enzyme and or activity level of the enzyme or number of tyrosine bonds found by analysis at any stage in the process. Any suitable analytical procedure could be followed, for example, by fluorescence detection, HPLC, NIR, or spectrophotometry. The spectrophotometric analysis can be done using fourier transformed infrared (FTIR) spectroscopy, Raman spectroscopy, and circular dichroism (CD), magnetic resonance spectroscopy. Following such analyses, the dough could be modified by the addition of the appropriate tyrosine bond formation modifier, preferably alcohol or enzyme, and in some situations, enzyme together with oxidizing agents, metal chelating agents, free radical scavengers, free tyrosine, or an adjustment of pH. Also, the physical mixing of the dough could be altered as necessary. This procedure could be carried out stepwise until the range of enzyme or tyrosine bonds is within a predetermined range for a given dough application.

Furthermore, the formation of dityrosine has been found to continue during the actual formation of the end-products as well as after end-product formation has ended. In other words, dityrosine levels continue to increase during and after baking. Thus, levels of dityrosine can be monitored at different stages of the baking process and at times after the baking process is complete in order to further optimize knowledge of end-product quality. In accordance with the present invention, the release of alcohol or enzyme can be controlled so as to be released at a specific stage in dough processing and/or end product formation in order to modify the formation of tyrosine bonds therein.

The present invention may also be utilized to affect tyrosine bond formation despite the fact that different cultivars of wheat contain different levels of tyrosine and dityrosine as well as different rates of dityrosine formation, all of which affect later processing steps used to make end-products. Moreover, cultivars generally considered to be of higher quality have or form little or no dityrosine in the developing or mature wheat kernels while cultivars of generally lower quality have elevated levels of dityrosine and greater rates of tyrosine bond formation in developing or mature wheat kernels. However, no mater what the levels of tyrosine or dityrosine are present in wheat kernels as they develop, the present invention affords a degree of control over the formation of tyrosine bonds in dough and end products, thereby resulting a greater consistency in the quality of products.

With respect to the wheat storage proteins, it is believed that glutenin has a major role in contributing to the dough forming characteristics of wheat flour. This is because all glutenin proteins have tyrosine (Y) and tyrosine, tyrosine pair (YY) repeats throughout their structure. Usually, these repeats are found in a YYPTS (SEQ ID NO. 8) motif or in the generalized peptide sequences, (1) peptides having the sequence XₐYYX_{b} (SEQ ID No. 1); (2) peptides having the sequence XₐQXGXYPTSX_{b} (SEQ ID No. 2); and (3) peptides having the sequence XₐGQGQXGXYPTSXQQX_{b} (SEQ ID No. 4), wherein each X independently represents any amino acid residue, and the sum of a+b ranges from 0-14. Particularly preferred isolated peptides include YY (i.e., a tyrosine pair), and QQGYYPTS (SEQ ID No. 9) or QPGYYPTS (SEQ ID No. 10). Different varieties of wheat have different numbers and locations of these repeat sequences in their amino acid profiles. It is these repeat sequences that are believed to be responsible for the majority of dityrosine formation in doughs and dough products. Thus, wheat “quality” in terms of any application for any end product may also be determined by the number and location of these repeat sequences within a particular variety of wheat.

Additionally, environmental conditions such as heat during wheat growth and kernel development also impact the formation of active enzyme forming subunits and tyrosine bonds thereby interfering with a flour's ability to form dough. In the case of wheat grown under high-heat conditions, higher levels of dityrosine are formed in the kernels which decreases the quality of doughs made from such wheat. The formation of high levels of dityrosine in the wheat kernels appears to interfere with and/or prevent later formation of dityrosine when such formation is desirable. This premature dityrosine formation may decrease the number of tyrosine residues available for tyrosine bonding or it may just hinder such bonding during dough processing. Different varieties of wheat are effected to different extents by these environmental conditions and thus, certain varieties of wheat are better suited for growth in particular environments. Using methods of the present invention, one can modify the amount of tyrosine bonding that occurs during dough formation and processing, thereby lessening the effects that these inherent levels may have. Such knowledge can be combined with the genetic engineering of wheat that includes manipulation of the levels of such residues and compounds. Alternatively, if these levels are being monitored during wheat growth and dityrosine formation is noted, steps may be taken to modify dityrosine formation during the processing thereof (e.g. by applying alcohol or enzyme). Thus, the effects of heat stress can be minimized through monitoring and manipulation of dityrosine formation and wheat producers can consistently grow crops of high quality which produce optimum end-products.

Additionally, the starting flour used to make the dough may be screened to predict the dough forming potential for a particular use prior to initiating any mixing. This screening is done in much the same way as the monitoring of dough during mixing. In this method, the approximate levels of enzyme, tyrosine, dityrosine, phosphotyrosine and/or tyrosine bonds in a flour sample are measured in order to assess and predict the dough forming potential based on the respective native, naturally occurring amounts of these compounds. Preferably the flour is analyzed to determine the amount of enzyme and/or the activity of the enzyme and the amount of tyrosine therein because the amount of tyrosine bonds therein is usually very small. Alternatively, the flour may be analyzed to determine the level of enzyme and dityrosine. These analyses are normally accomplished by measuring the content of enzyme, tyrosine and/or dityrosine in the flour. This provides the advantage of a screening technique that is more sensitive than the on-line technique method of analyzing the tyrosine bonds and/or enzyme during dough manufacture. Knowledge of the enzyme, tyrosine, dityrosine, phosphotyrosine and tyrosine bond content of the storage proteins (glutenin and gliadin) in flour to be used in the dough forming process can reduce the amount of on-line manipulation needed to produce an optimum dough for a particular use. Furthermore, this knowledge allows the operators of the machinery used in dough manufacture to precalibrate their mixing apparatus thereby facilitating production of an optimum dough with a minimum of manipulation.

Finally, analysis of the approximate levels of enzyme and enzyme in combination with tyrosine, dityrosine, phosphotyrosine and/or tyrosine bonds in developing wheat kernels and/or wheat flour samples contributes to a method of “grading” wheat and/or flour. Flours may be grouped according to such levels found within the storage protein chains. It is believed that the glutenin subunits, and especially the YYPTS or QQGYYPTS motif repeats of the gluten protein chains occupy a more significant role with respect to a dough's viscoelastic properties. However, the gliadin subunits may still be of importance with respect to tyrosine bonds and their effect on a dough's physical characteristics. Flours having enzyme or enzyme and tyrosine, phosphotyrosine, dityrosine and/or tyrosine bond levels falling within a certain range would be grouped together and designated as having a certain grade. Alternatively, the numbers and locations of these motifs in the amino acid profiles of the wheat could also be determined and a grading scale developed. The grade would therefore indicate the approximate range of enzyme or enzyme and tyrosine and/or tyrosine bonds inherent in the flour or the number and locations of these motif repeats. This would allow users of flour for different applications to choose a flour that has a desired starting amount of enzyme or enzyme and tyrosine and/or tyrosine bonds or a particular number or location of these motif repeats which would contribute to the consistent production of high quality end-products.

### BRIEF DESCRIPTION OF THE DRAWINGS

FIG. 1 is a photograph of the 20 Rotofor fractions obtained from the water soluble extract of a flour;

FIG. 2 is a graph illustrating the relative activity of the 20 Rotofor fractions;

FIG. 3 is a graph illustrating the amount of dityrosine catalyzed by fraction 20.

FIG. 4 is a photograph of a Western Blot using HRP antibodies and photograph of a Coomassie stain from fraction 20 of the Rotofor fractions;

FIG. 5 is a photograph of an SDS-PAGE analysis of fraction 20 of the Rotofor fractions;

FIG. 6 is a graph illustrating the effect of protease on dityrosine formation;

FIG. 7A is a mixogram of durum wheat flour without added WSE;

FIG. 7B is a mixogram of durum wheat flour with added WSE;

FIG. 8 illustrates the nucleotide and deduced amino acid sequence of GenBank Accession No. AY212922; and

FIG. 9 illustrates a comparison of the amino acid sequences from BP 1 and WP 1.

### DETAILED DESCRIPTION OF THE PREFERRED EMBODIMENT

The following examples set forth preferred embodiments of the present invention. It is to be understood, however, that these examples are provided by way of illustration and nothing therein should be taken as a limitation upon the overall scope of the invention.

### EXAMPLE 1

This example fractionated the water soluble extract of flour and the fractions were tested for peroxidase activity.

Materials and Methods:

Protein Purification. The albumin fraction, or water soluble extract (WSE), of Bronze Chief flour (Wheat Montana, Three Forks, Mont.) was fractionated by the separtion of components via preparative isoelectric focusing using the BioRad Rotofor apparatus (BioRad Laboratories, Hercules Calif.) with a pH gradient of 3-10. WSE was prepared by mixing 30 g of flour in 90 ml of ddH₂O for 45 minutes. WSE was precipitated with 50% (w/v) ammonium sulfate and centrifuged at 10,000×g for 10 minutes at 4° C. The supernatant was collected and dialyzed against water o/n (6,000-8,000 MWCO). The dialyzed material was brought to 4M urea and separated via preparative isoelectric focusing using the BioRad Rotofor apparatus with the addition of 3% pH 3-10 ampholytes. The resulting 20 fractions were collected and tested for peroxidase activity with the peroxidase substrate, tetramethylbenzidine (TMB) measuring absorbance at 630 nm (10 ul sample was added to 500 ul of TMB).

Results:

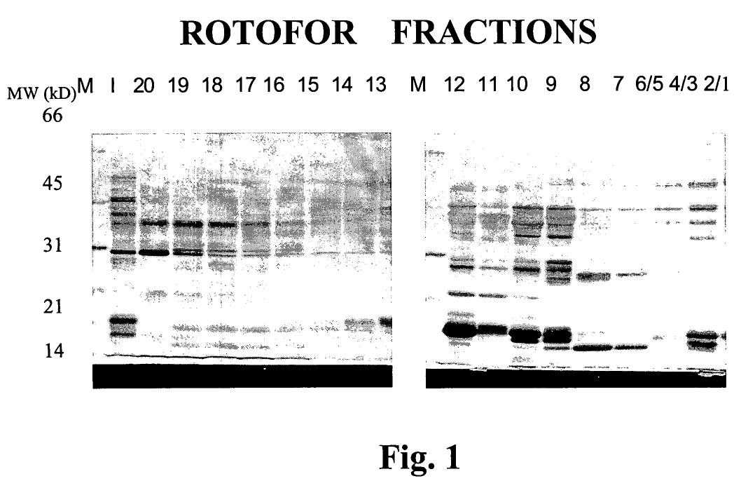

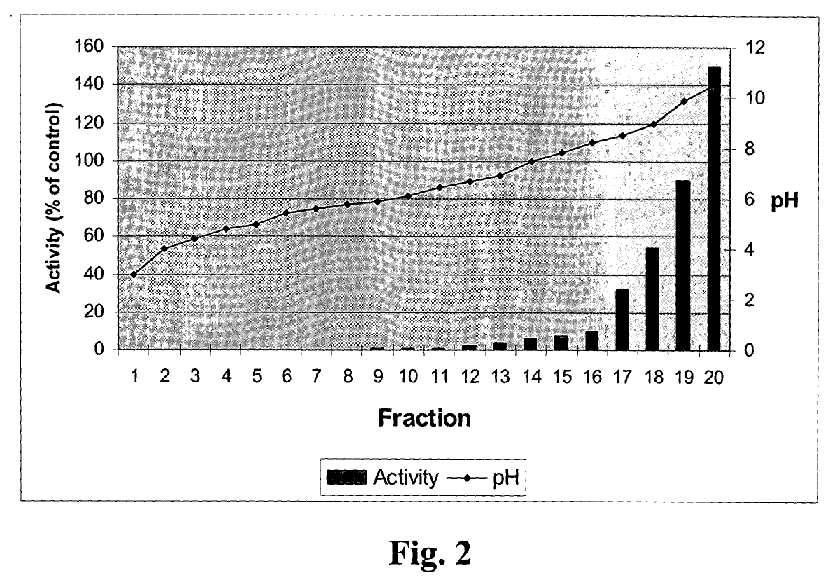

Using the WSE as a positive control, activity was first observed in fraction 13 and the activity of each succeeding fraction increased. The activity of fraction 19 was equal to that of the positive control (the WSE) and fraction 20 (pH 11.3 5) displayed activity that was three times greater than that of fraction 19 and the positive control. An SDS-PAGE analysis of the Rotofor fractions is shown in FIG. 1 and a graph illustrating the activity of each fraction is shown in FIG. 2.

### EXAMPLE 2

This example tested the each of the fractions produced in Example 1 for dityrosine forming activity.

Materials and Methods:

Each of the 20 fractions produced in Example 1 were tested in a single blind assay for dityrosine formation with appropriate controls. Tyrosine (0.1 mg) was added to 1.0 mL of each of the 20 fractions. The mixtures were incubated at 37 C for 24 hours. The mixtures were then lyophilized to dryness. Each sample of lyophilized material was placed in 6 N HCl/1% phenol and evacuated for hydrolysis. The hydrolysis was accomplished under vacuum at 110° C. for 24 hours. Phenol and HCl were completely evacuated under vacuum, and residual materials were reconstituted in double distilled H₂O and filtered. Amino acids were separated by liquid chromatography using a reversed phase column (LUNA RP 5 μm C18, 2; 205×4.6 mm, Phenomenex, Torrance, Calif.) and stepwise gradient (3, 10, 40, 95, 95, and 3%) of acetonitrile containing 1% trifluoroacetic acid at 0, 35, 50, 60, 65, and 85 minutes, respectively, a flow rate of 1 mL/minute, and a column temperature of 30° C. The eluent was monitored simultaneously at 285 nm by an HP diode array detector and by an HP fluorescence detector set at 285 and 405 nm, excitation and emission wavelengths, respectively.

Results:

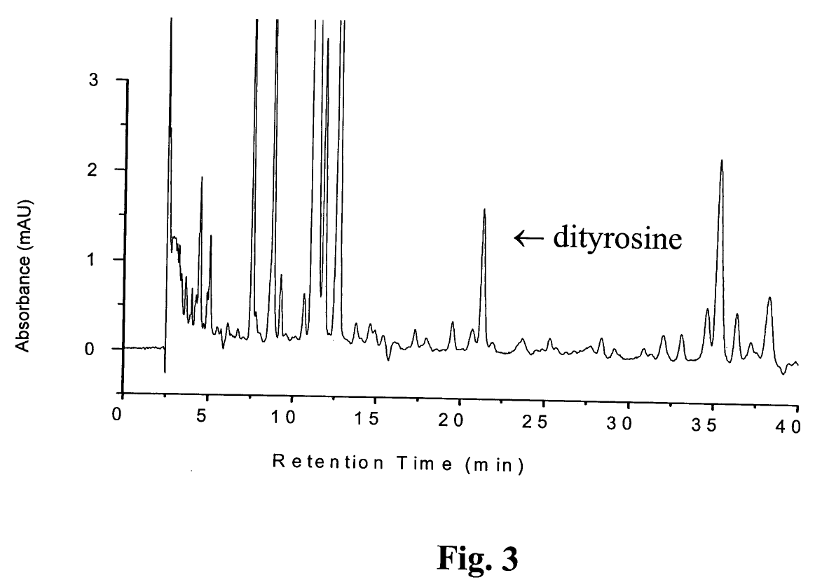

FIG. 3, illustrates the amount of dityrosine catalyzed by fraction 20 in vitro. These results confirm that the WSE of Bronze Chief flour contains a component that catalyzes the formation of tyrosine bonds.

### EXAMPLE 3

This example identified the peroxidase enzymes using antibodies to horseradish peroxidase.

Materials and Methods:

SDS-PAGE and Western Blot Analysis were performed on the total water-soluble extract (WSE) and each of the isolated fractions using the Novex system (Invitrogen Carlsbad, Calif.) using 12% gels followed by staining with Coomassie. The Western blotting technique followed that taught by Towbin H., Staehlin T. and Gordon J. Electrophoretic transfer of proteins from polyacrylamide gels to nitrocellulose sheets: procedure and some applications. 76 Proc. Natl. Acad. Sci. U.S.A.; 4350-4354 (1979) (the content and teachings of which are incorporated by reference herein. Briefly, gels were transferred to nitrocellulose and probed with antibodies to horseradish peroxidase (HRP) conjugated with alkaline phosphatase (Jackson ImmunoResearch Laboratories Inc., West Grove Pa.) and used in Western blot analysis of the total water-soluble extract and isolated fractions. The blots were blocked with membrane blocking solution (Zymed S. San Francisco, Calif.) then probed with anti-HRP diluted 1:10,000 for 1 hour, washed, and then developed with BCIP/NBT (BioFX, Owings Mills, Md.). Antibodies to HRP recognized a protein of approximately 38 kDa in fraction 20. Western blotting was done in accordance with the teachings of Towbin H., et al., Electrophoretic transfer of proteins from polyacrylamide gels to nitrocellulose sheets: procedure and some applications. 76 Proc. Natl. Acad. Sci. U.S.A., Pages: 4350-4354 (1979) (the content and teachings of which are hereby incorporated by reference herein).

Results:

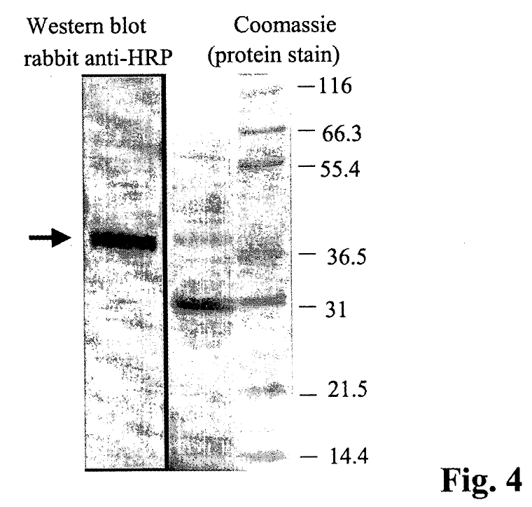

As shown in FIG. 4, the protein profile using SDS-PAGE analysis revealed multiple bands in fraction 20. The HRP antibodies recognized a protein of approximately 38 kDa in fraction 20.

### EXAMPLE 4

This example further fractionated and purified the components of fraction 20.

Materials and Methods:

The components of fraction 20 were further fractionated to isolate the ˜38 kDa protein that was recognized by the anti-HRP antibodies by precipitating the WSE of fraction 20 with 50% (w/v) ammonium sulfate and centrifuged at 10,000×g for 10 minutes at 4° C. The supernatant was collected and dialyzed against water overnight (6,000-8,000 Molecular Weight Cut Off (MWCO) Size). The dialyzed material was applied to the Rotofor with a pH gradient of 3-10. Fractions were again tested for peroxidase activity as described in Example 1 and the samples which exhibited activity greater than the control (the WSE) were saved. Fractions 18-20 (pH range of 9 to 10.6) all had greater activity than the control with the greatest amount of activity occurring again in fraction 20.

Fraction 20 was passed through an affinity column and eluted with 0.1 M glycine (pH 2.8). The affinity column was prepared using the Pierce ImmunoPure ProteinG IgG Plus Orientation Kit (Pierce Rockford, Ill.) and antibodies to HRP (Jackson ImmunoResearch Laboratories, Inc. West Grove, Pa.). The eluate was analyzed by SDS-PAGE.

To determine dityrosine forming ability, one mL of the eluate that contained two bands (30 kDA and 38 kDa) was added to 0.1 mg of tyrosine (Sigma, St. Louis, Mo.) in a tube and incubated at 37° C. for 24 hours. The sample was vacuum dried and submitted for amino acid analysis. The amino acid analysis protocol utilized has been previously described by Malencik et al., 184 Anal Biochem., 353-359 (1990) and by Tilley et al., 49 J. Ag and Food Chem. 2627-2632 (2001) (the content and teachings of which are hereby incorporated by reference).

Results:

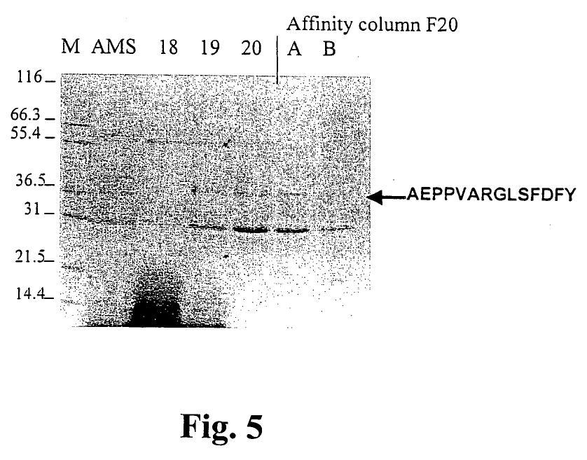

As shown in FIG. 5, the eluate revealed 2 primary bands at approximately 38 and 30 kDa, respectively. The 38 kDa band was recognized by HRP antibodies in a Western Blot assay as shown in FIG. 4. The 30 kDa band was not recognized by the HRP antibodies. The two bands caused dityrosine formation during incubation with free tyrosine in vitro. If the bands are similar in function to those found in the BP 1 enzyme from barley, the two bands represent differently glycosylated forms of the same enzyme.

### EXAMPLE 5

This example determined the N-terminal sequence of the 38 kDa band.

Materials and Methods:

The two fractions eluted in Example 4 were lyophilized to dryness and analyzed by SDS-PAGE blotted to PVDF membrane using CAPS buffer, stained with 0.1% Serva Blue R (Serva electrophoresis GmbH Heidelberg, Germany) in 50% methanol for 5 minutes. Next, the fractions were destained in 50% methanol (no acetic acid) three times for 5 minutes each, and washed three times in ddH₂O for 15 minutes each. The resulting blot was air dried and placed at −20° C. One of four tracks was used for the N-terminal sequencing.

Results:

The N-terminal sequence of the 38 kDa band was determined to be AEPPVARGLSFDFYRRTCPRAES (SEQ ID No. 11). This protein was compared to other sequences in GenBank using the procedures of Altschul, et al., Gapped BLAST amd PSI-BLAST: A New Generation of Protein Database Search Programs, 25 Nucleic Acids Res. 3389-3402 (1997) and found to have 91% similarity to the N-terminus of barleyperoxidase BP 1. The active BP 1 enzyme consists of 309 amino acids (SEQ ID No. 12) and occurs in two forms. BP 1 is glycosylated and found to be different from other peroxidases (sequence similarity of 23-47% with pox 1-4, thereby indicating its potentially unique biological functions. The BP 1 protein has previously been identified using reversed phase HPLC analysis and SDS-PAGE analysis of the water soluble albumin fraction of Chinese Spring wheat endosperm. The first 10 amino acids are identical to the first 10 amino acids of SEQ ID No. 7. However, no functional properties of this protein (BP 1) during dough formation or in the breadmaking process have been proposed.

### EXAMPLE 6

This example illustrates the effect of protease on dityrosine forming activity of the WSE.

Materials and Methods:

The ability of WSE to catalyze the formation of dityrosine (as shown in Example 2) was negated upon exposure to protease. To obtain the control profile, 0.1 mg of tyrosine was incubated with 1 mL of water-soluble extract of flour for 24 hours at 37° C. The sample was then freeze-dried. Hydrolysis and amino acid analysis were performed as previously described herein. To obtain the profile of the protease-treated sample, 1 mL of the water soluble extract of flour was incubated with bovine pancreas protease (2 mg/mL) (Sigma Chemical Co, St. Louis, Mo.) for 24 hours at 37° C. The samples were then freeze-dried and hydrolysis and amino acid analysis were performed as previously described herein.

Results:

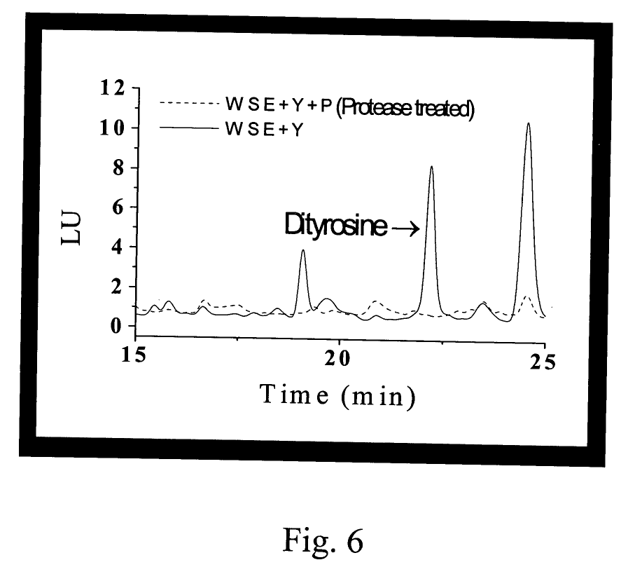

The results of this Example are provided in FIG. 6 which shows that the addition of protease negatively affected dityrosine formation.

### EXAMPLE 7

This Example compared a durum flour with durum flour plus WSE in mixogram analyses.

Materials and Methods:

Durum flour (10 grams) (American Italian Pasta Company, Excelsior Springs, Mo. (10.01% protein) was used in mixograph analyses using AACC method 54-40A and compared to the same durum flour after the addition of the WSE (6.0 mL) from bread wheat flour (cv. Bronze Chief, Wheat Montana, Three Forks, Mont., 14.76% protein).

Results:

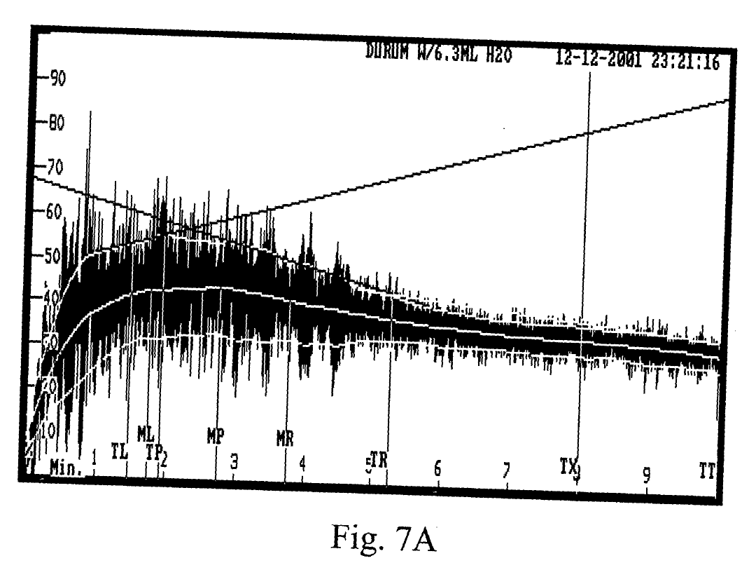

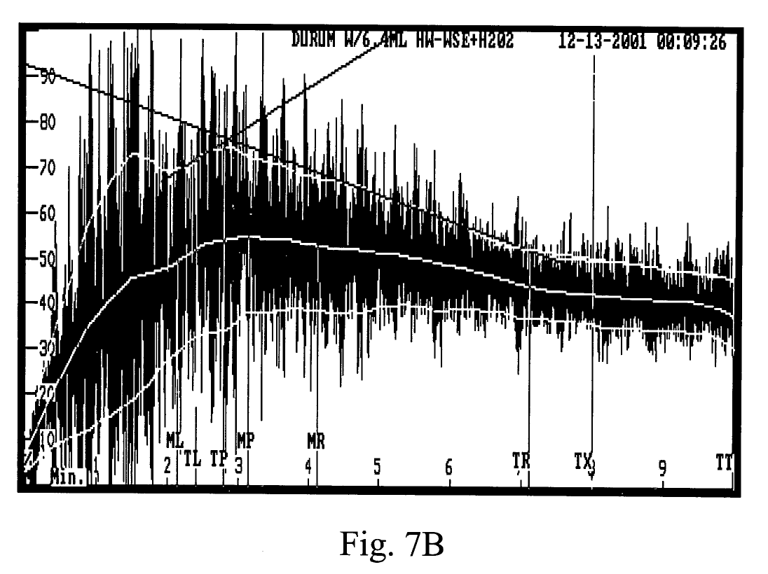

The WSE from the Bronze Chief flour exhibited a strengthening effect on the durum flour. These results are shown in FIGS. 7A and 7B.

### EXAMPLE 8

This example compares the cDNA encoding the endosperm peroxidase from hexaploid wheat and an ancestral grass species, Ae. tauschii, to that of BP 1.

Materials and Methods:

The cDNA encoding the wheat endosperm peroxidase was isolated using a 66mer oligonucleotide. The oligonucleotide sequence was derived from the barley BP1 N-terminal amino acid sequence (SEQ ID No. 13) (GenBank Accesion No. M73234) with the substitution of the codon encoding the first R for P at position 7 (ccc to cgg) as determined in the N-terminal sequence of the wheat peroxidase WP1 (SEQ ID No. 11) (Caruso, C. et al., A basic peroxidase from wheat kernel with antifungal activity; 58 Phytochemistry, 743-750. (2001) the content and teachings of which are hereby incorporated by reference). The oligonucleotide was labeled with digoxygenin (DIG) using the DIG oligonucleotide 3 tailing kit (Roche Applied Science, Indianapolis, Ind.[city and state]) as described by the manufacturer. A wheat kernel (cv. Cheyenne) cDNA library in lamda Zap II and cDNA library from developing kernels of the wheat D-genome ancestral species Aegilops tauschii in pCMV SPORT6 vector were screened separately. Upon analysis of the sequence, it was observed that the two sequences are identical at the nucleotide and amino acid levels and for simplicity, the sequence from Ae. tauschii is presented. The high level of sequence homology/identity between sequences of T. aestivum and Ae. tauschii endosperm peroxidase is consistent with recent evidence concerning the evolutionary role of Ae. tauschii as contributor of the D-genome to hexaploid wheat (See, Huang, S. et al., Genes encoding plastid acetyl-CoA carboxylase and 3-phosphoglycerate kinase of the Triticum/Aegilops complex and the evolutionary history of polyploid wheat; 99 Proceedings of the National Academy of Sciences, USA; 8133-8138.(2002) the content and teachings of which are hereby incorporated by reference).

Results:

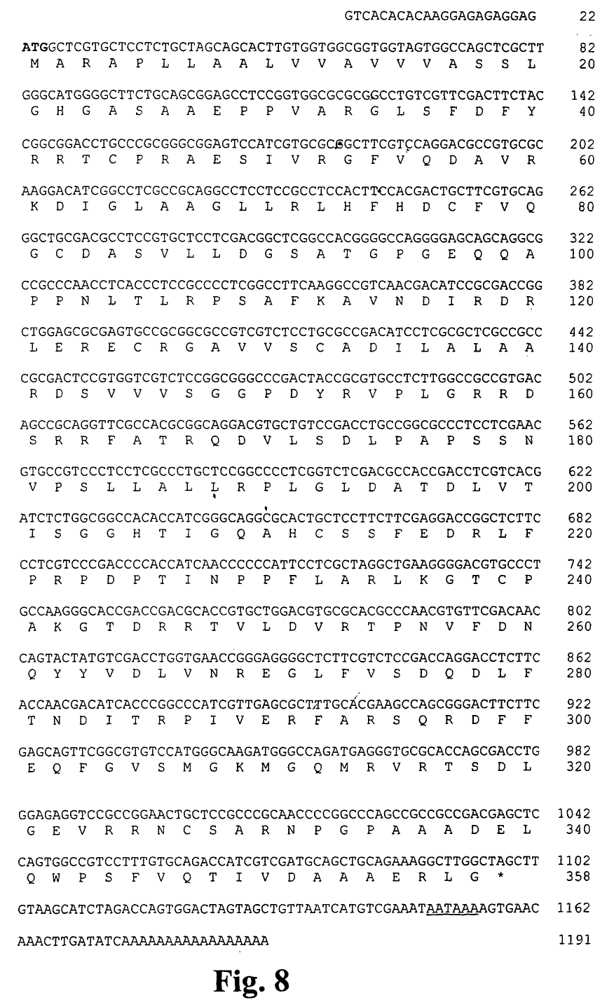

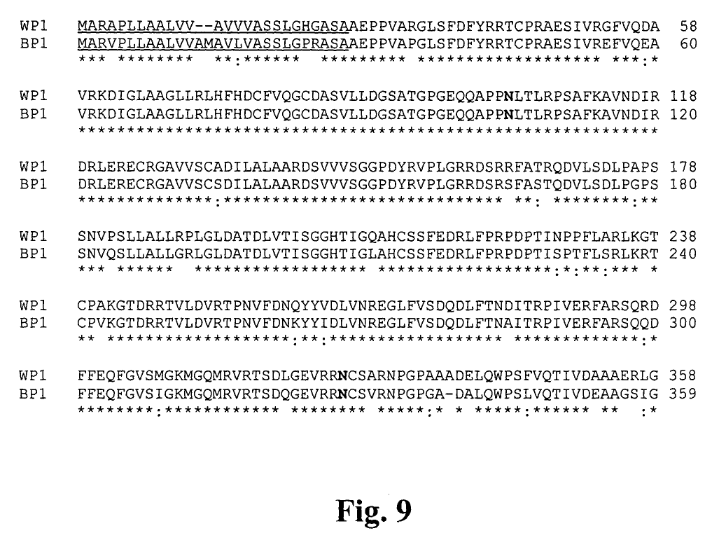

FIG. 8 shows the nucleotide sequence of the full length cDNA (SEQ ID NO. 14) (GenBank accession no. AY212922) as well as the deduced amino acid sequence (SEQ ID No. 15) and FIG. 9 compares the deduced amino acid sequence of the peroxidase from Ae. tauschii with that of BP 1. The sequence contains an open reading frame (ORF) of 1077 nucleotides that encodes a polypeptide of 358 amino acids. The protein contains a 26 amino acid signal sequence (SEQ ID No. 16) that agrees with previously described reports of the N-terminal sequence of wheat endosperm peroxidase. Examination of the amino acid sequences revealed two potential N-glycosylation sites as determined by the occurrence of the Asn-X-Ser/Thr motif using an NetNGlyc prediction tool that utilizes trained neural networks to predict N-glycosylation sites (Gupta, R.; et al., Prediction of N-glycosylation sites in human proteins; In preparation (2002)), and description of BP 1 (Johansson, A., et al., cDNA, amino acid and carbohydrate sequence of barley seed-specific peroxidase BP 1 18 Plant Molecular Biology, 1151-1161 (1992), the content and teachings of which are hereby incorporated by reference). Thus, it appears that WP 1 is similar to BP 1 in that it has two forms, one of which is glycosylated. These two forms are both within the 38 kDa band and cannot be well separated except by using a concanavalin A affinity column. Such glycosylation can affect how proteins behave, their charge, their conformation, and how they interact with other proteins.

Comparison of the sequences with other known sequences was performed using the GenBank Blast program and revealed a near identical match (99% at the nucleotide level, 100% at the amino acid level) to a recent unpublished submission present in GenBank for wheat endosperm peroxidase (accession # AF525425). Additionally the sequence was found to share a significant degree of homology, 89%, with the barley endosperm peroxidase BP 1 (SEQ ID No.12), with many of the amino acid substitutions being conserved. The BP 1 cDNA encodes a protein of 359 amino acids, however the active BP 1 enzyme consists of 309 amino acids due to a 28 amino acid signal sequence compared to a 26 amino acid signal sequence in the T. aestivum and Ae. tauschii proteins. In addition, a C-terminal peptide of 22 amino acids is removed from BP 1 in the active enzyme and, although the C-termini of the described proteins agree with the pro-peptide of BP 1, it is not known if the T. aestivum and Ae. tauschii enzymes are processed similarly.

Analysis revealed little (39-45%) homology to other described wheat peroxidases (pox 1-4). Comparisons with other peroxidases at the protein level revealed the following levels of homology: Pox 1: 39%; Pox2: 45%; Pox3: 44%; Pox4: 44%; HRP-C 41%.

The active sites in peroxidases are similar for all peroxidases (including WP 1) and they are well-defined in terms of the structure required for activity. Accordingly, when WP 1 is the peroxidase of choice, it is believed that sequences having as little as 70% sequence homology with WP 1 would be effective for methods of the present invention. Preferably the active sites would not be modified. Still more preferably, the sequences would have 75, more preferably 80, 85, 90, 95, 97, 98, and 99% sequence homology with WP 1. Furthermore, it is believed that sequences that would have a reaction with HRP antibodies would also be effective for purposes of the present invention.

### EXAMPLE 9

This example provides a conventional method of encapsulating the enzyme such that the enzyme is released upon the occurrence of a condition.

Materials and Methods:

A water insoluble coating material such as wax or fat is selected and melted. The selection is based on the temperature at which the material would melt. A sample of enzyme or free radical scavenger such as mannitol is then dispersed into a quantity of the melted liquid coating material. The mixture is then sprayed into a cool-air tower where the coating hardens around the enzyme or free radical scavenger core to form a co-refilled bead.

Results:

In this spray congealing method, the particles are formed through cooling rather than through heat (as in the spray drying process). This method is useful for preparing encapsulates that protect the core from moisture and release at a specific temperature. Such an encapsulated core could be added to a dough mixture and the enzyme or free radical scavenger would be released during the baking process once the melting temperature of the coating material was released.

### EXAMPLE 10

This example illustrates one method of determining and setting an optimum range standard for enzyme in a given wheat flour-containing product. Finding a predetermined optimum standard for such products allows the producer of the product or machinery operator to compare the range or amount of enzyme present in a production run to that of an ideal product, thus permitting real-time modification of the product.

Materials and Methods

This standard is found by producing the wheat flour-containing product under optimum processing conditions and taking samples at various stages of the production process. These samples are analyzed to determine the approximate amount of enzyme present in the sample at each stage. This could be done with an infinitely large number of samples at an infinitely large number of stages in the process (e.g. every minute, every second, every 1/10th of a second, etc.) in order to provide as narrow of a target or optimum range as possible. The range or amount of enzyme found at each stage of the processing of ideal products is then used as a benchmark to control future processing of that particular product. The amount of enzyme found at each stage of processing is compared to the optimum or ideal number for that stage and any necessary modifications for bringing the amount of enzyme within the optimum range are made, thereby ensuring that an optimum product is made every time.

Preferably, this entire process is done through a computer program configured to direct the processing of any product utilizing tyrosine bonds. For example, the preferred computer program is designed to direct the operator of the equipment to either manually or automatically:
1) Direct random analyses of the material being processed in order to determine the approximate amount of enzyme at that stage of the processing;
2) Compare the analyzed range found to the optimum range for that stage of the process;
3) Direct the modification of the product as necessary with any useful methods to bring the amount of enzyme into the ideal range; and
4) Repeat as necessary or as often as desired for each run.

Of course, all of the foregoing can be combined with other technology related to the manipulation of tyrosine bonding in order to further control the formation of tyrosine bonds. Exemplary methods may be found in U.S. patent application Ser. No. 09/491,259, filed Jan. 26, 2000 (the content and teachings of which are hereby incorporated by reference herein).

Results:

Comparing the analyzed ranges from each production run with the predetermined ideal standard allows for the production of products that consistently exhibit optimum characteristics. Of course, the ideal range of enzyme will be more accurate if many samples are taken from many different production runs that result in ideal products. This method is useful for all products utilizing tyrosine bonds in that ideal ranges of enzyme may be found and used to govern subsequent production of each product. Furthermore, the ideal range may be based on the amount of active enzyme needed to catalyze the proper amount of bonds between and among tyrosine residues or between tyrosine residues and other compounds (which may bridge storage protein chains or be storage protein chain substituents) such as quinones, hydroquinone, dihydroxyphenylalanine, dopaquinone, semiquinones, glutathione, cysteine, catechols, various carbohydrates and analogs thereof (tyrosine bonds), all of which may be measured using the methods outlined in the examples above.

Other advantages deriving from the use of a predetermined standard are that modification of the amount of enzyme found at a given stage during any production run based on the ideal range of enzyme that should be exhibited at that stage results in a subsequent reduction of product that does not meet quality control standards and therefore, a reduction in wasted product. This will also thereby reduce the operating costs associated with wasted product and standardize quality control. Moreover, the parameters controlling the modification of the amount of enzyme can be easily changed should the ideal range ever need to be adjusted.

### EXAMPLE 11

This example describes methods of altering the expression of enzyme in a plant gene.

Materials and Methods:

Methods to introduce or increase WP 1 expression in a plant involve the construction of a chimeric gene designed to maximize expression. Some examples of conventional methods may be found in U.S. Pat. No. 5,424,412, the content and teachings of which are hereby incorporated by reference herein. When expressed in a transgenic plant, the chimeric plant genes provide greater quantities of the WP 1 protein encoded by the coding sequence in the chimeric gene. Chimeric genes are constructed by conventional methods by inserting a plant promoter, a scorable marker coding sequence, and a polyadenylated coding sequence in an expression vector that contains appropriate restriction sites, which permit the insertion of a structural DNA sequence encoding the WP 1 protein. This may utilize different and possibly multiple promoters and/or enhancer sequences that may be more potent in the respective host plant as well as tissue and/or developmental specific promoters that will optimize the effect of WP 1 expression. The chimeric WP 1 gene will be inserted into many plant transformation vectors suitable for transformation into the desired plant species such as those derived from a Ti plasmid of Agrobacterium tumefaciens. Transformation of plant cells may be performed by delivery of a transformation vector or free DNA by use of a particle gun which comprises directing high velocity microprojectiles coated with the vector or DNA into plant tissue. Selection of transformed plant cells and regeneration into whole plants maybe carried out using conventional procedures. Other transformation techniques capable of inserting DNA into plant cells may be used, such as electroporation or chemicals that increase free DNA uptake.

Any promoter that is known or found to cause transcription of DNA in plant cells can be used in the present invention. Transformation and regeneration protocols for Monocots are known in the art. After the plant has been transformed and after transformed callus has been identified, the transformed callus tissue is regenerated into whole plants. Any known method of regeneration of plants can be used.

Results:

Protein expression will be evaluated by Western blot, ELISA or activity assay. Changes in functional properties will be measured according to the desired changes and correlated to analysis of dityrosine crosslink formation.

We claim:

1. A method of altering dough formation characteristics comprising the steps of::
mixing flour and water to form a dough; and a step selected from the group consisting of:
adding an amount of an ingredient to said dough, said ingredient being selected from the group consisting of peroxidase enzyme, protease, and alcohol;
modifying the amount of peroxidase-coding DNA sequences in said flour;
modifying the expression of peroxidase coding DNA sequences in said flour;
adding an amount of protease to said flour;
adding an amount of alcohol to said flour; and
combinations thereof.

2. The method of claim 1, said adding step occurring during said mixing step.

3. The method of claim 1, said adding step occurring prior to said mixing step.

4. The method of claim 1, said peroxidase enzyme being WP 1 or being selected from the group consisting of NADH₂ peroxidase fatty-acid peroxidase, tryptophan 2,3-dioxygenase, cytochrome-c peroxidase, catalase, peroxidase, iodide peroxidase, glutathione peroxidase, chloride peroxidase, L-ascorbate peroxidase, phospholipid-hydroperoxide glutathione peroxidase, manganese peroxidase, diarylpropane peroxidase, and sequences which include the sequence of SEQ ID No. 7.

5. The method of claim 1, said ingredient being encapsulated so as to be released as a result of a certain condition.

6. The method of claim 5, said certain condition being selected from the group consisting of the passage of a certain amount of time, the reaching of a certain temperature, the reaching of a certain pH, or the reaching of a certain percentage of water hydration.

7. A method of altering dityrosine formation during the mixing of a dough comprising the step of contacting said dough with an ingredient selected from the group consisting of peroxidase, alcohol, protease, flour with a modified level of peroxidase therein, flour modified to express a greater amount of peroxidase, and combinations thereof.

8. The method of claim 7, said peroxidase being selected from the group consisting of WP 1, NADH₂ peroxidase fatty-acid peroxidase, tryptophan 2,3-dioxygenase, cytochrome-c peroxidase, catalase, peroxidase, iodide peroxidase, glutathione peroxidase, chloride peroxidase, L-ascorbate peroxidase, phospholipid-hydroperoxide glutathione peroxidase, manganese peroxidase, diarylpropane peroxidase, and sequences which include the sequence of SEQ ID No. 7.

9. The method of claim 7, said ingredient resulting in an increase in dityrosine formation.

10. A method of determining the approximate amount of active peroxidase in a dough comprising the steps of:
combining dough forming ingredients to form a dough;
mixing said dough; and
during said mixing step, analyzing said dough to determine an approximate amount of active peroxidase in said dough.

11. The method of claim 10, further comprising the step of comparing said determined amount of peroxidase with a predetermined standard.

12. The method of claim 11, further comprising the step of predicting dough quality by said comparison.

13. The method of claim 10, said analyzing step being performed a plurality of times, each of said plurality of times occurring at different stages of said mixing step.

14. The method of claim 10, further comprising the step of measuring tyrosine bond formation.

15. The method of claim 10, said active peroxidase being determined using tetramethylbenzidine.

16. A method of making a dough comprising the steps of:
combining dough forming ingredients to form a dough;
mixing said dough;
during said mixing step, analyzing said dough to determine respective approximate ranges of the amount of active peroxidase in said dough; and
comparing said analyzed ranges of peroxidase to a predetermined optimum range standard in order to achieve an optimum range of peroxidase in said dough.

17. The method of claim 16 further including the step of manipulating the amount of or activity of peroxidase in said dough.

18. The method of claim 16 further comprising the step of adding an ingredient to said dough as a result of said determined range of peroxidase in said dough.

19. The method of claim 18, said ingredient selected from the group consisting of peroxidase, protease, alcohol, and combinations thereof.

20. An isolated protein having the sequence of SEQ ID No. 7.

21. The protein of claim 20, said protein being recombinant.

22. A transformed DNA sequence which encodes the protein of SEQ ID No.7.

23. A method of altering a crosslinking property of a protein containing tyrosine bond forming subunits therein, said method comprising the step of:
contacting said protein with an ingredient selected from the group consisting of peroxidase, protease, alcohol, and combinations thereof.

24. The method of claim 23, said crosslinking property being an intraprotein crosslinking property.

25. The method of claim 23, said crosslinking property being an interprotein crosslinking property.

26. The method of claim 23, said protein being selected from the group consisting of plant proteins, and synthetic proteins.

27. A method of altering the formation of polymers that incorporate a crosslinker, said cross linker being selected from the group consisting of peptides having a sequence selected from the group consisting of SEQ ID NOS 1-5 and reversals of SEQ ID NOS 1-5, wherein each X independently represents any amino acid residue, and the sum of a+b ranges from 0-14, said method comprising the step of contacting said crosslinker with an ingredient selected from the group consisting of peroxidase, protease, alcohol, and combinations thereof.

28. The method of claim 27, said polymers being selected from the group consisting of biopolymers and synthetic polymers.

29. A method of altering a crosslinking property of a protein containing tyrosine bond forming subunits therein, said method comprising the step of:
contacting said protein with an ingredient selected from the group consisting of peroxidase, protease, alcohol, and combinations thereof.

30. The method of claim 29, said crosslinking property being an interprotein crosslinking property.

31. The method of claim 29, said protein being selected from the group consisting of plant proteins, and synthetic proteins.

32. The method of claim 31, said plant protein being selected from the group consisting of wheat, soy, corn, rye, oats, triticale, sorghum, rice, and barley.

33. A method for assessing dough formation comprising the steps of:
combining dough-forming ingredients to form a dough and mixing the dough; and
during said mixing step, analyzing said dough to determine an approximate range of active peroxidase within the dough.

34. The method of claim 33, wherein said analysis is performed by a step selected from the group consisting of fluorometry, HPLC, NIR, spectrophotometry, and combinations thereof.

35. The method of claim 33, said method further comprising the step of determining the amount of tyrosine bonds in the dough.

36. A method of making a dough comprising the steps of:
combining dough-forming ingredients to form a dough and mixing the dough;
during said mixing step, periodically analyzing the dough to determine respective approximate ranges of the amount of active peroxidase therein; and
comparing said analyzed ranges of active peroxidase to a predetermined optimum range standard in order to achieve an optimum range of active peroxidase in the dough.

37. The method of claim 36, further including the step of manipulating the range of active peroxidase within said dough.

38. The method of claim 36, further including the step of stopping the mixing when the predetermined optimum range is reached.

39. The method of claim 36, wherein the periodic analyzing of the dough is done by fluorometry, NIR, spectrophotometry, HPLC, or combinations thereof.

40. The method of claim 37, wherein said manipulation step is selected from the group consisting of:
adding an amount of peroxidase to the dough, adding an amount of protease to the dough;
adding an amount of a free radical scavenger to the dough;
altering the amount of active peroxidase expressed by the flour fraction of the dough; and
combinations thereof.

41. The method of claim 37, wherein said manipulation of the range of active peroxidase within the dough is done in response to said comparison of said analyzed peroxidase range to said predetermined range.

42. The method of claim 37, wherein said manipulation of the range of active peroxidase in the dough is controlled by a computer program configured to achieve the desired range of active peroxidase by directing said manipulation in response to said analysis.

43. A method of analyzing flour to determine the approximate levels of active peroxidase contained therein comprising the steps of:
taking a sample of flour; and
analyzing said sample for said level(s).

44. The method of claim 43, further including the step of comparing said level(s) to a predetermined standard.

45. The method of claim 43, further including the step of precalibrating dough processing equipment based on said level(s).

46. The method of claim 43, wherein said analysis is performed by a method selected from the group consisting of measuring the content of peroxidase coding sequences in the DNA of said flour using fluorometry, NIR, spectrophotometry, or HPLC.

47. The method of claim 43, further including the step of grading the quality of the flour based on the level of peroxidase therein.

48. The method of claim 47, said grading step including the step of comparing said level(s) to a predetermined standard indicative of flour quality.

49. A dough including the analyzed flour of claim 43.

50. A method for determining an ideal range of the amount of active peroxidase for a given stage of a dough production process comprising the steps of:
(a) preparing an ideal product using said production process;
(b) taking at least one sample during said production of said product; and
(c) analyzing the range of active peroxidase present in said sample for at least one stage of the production process.

51. The method of claim 50, wherein said analyzed range is designated as said ideal range for said stage.

52. The method of claim 50, wherein steps (a)-(c) are repeated a plurality of times for each said stage of said process.

53. The method of claim 52, wherein each said analyzed range for each said stage is averaged with the plurality of other analyzed ranges from corresponding stages from each other said repeated analysis in order to compute said ideal range for a specific stage from a plurality of samples.

54. A dough produced by the process of claim 16.

55. A dough produced by the process of claim 36.

56. In a dough comprising admixed wheat flour and water, the wheat flour fraction of the dough having an inherent amount of active peroxidase therein when the dough during mixing thereof reaches a desired optimum condition, and wherein during continued mixing of the dough after said desired optimum condition is reached, the amount of tyrosine bonds in the wheat flour fraction increases to an undesirable amount, the improvement which comprises the addition of an additive which reduces further formation of tyrosine bonds catalyzed by said peroxidase in said wheat flour fraction of the dough during said continued mixing of the dough after said desired optimum is reached, as compared with said undesirable amount of tyrosine bonds.

57. The dough of claim 56, said additive being selected from the group consisting of free radical scavengers and protease.

58. The dough of claim 57, said free radical scavenger being selected from the group consisting of ascorbic acid, mannitol, sorbitol, xylitol, and glycerol.

59. The dough of claim 56, said free radical scavenger or protease being encapsulated so as to be released once a certain condition of the dough is reached or a certain amount of time after mixing begins has elapsed.

60. A dough comprising admixed wheat flour, water and an additive, said dough exhibiting a specific viscoelasticity at an optimum dough condition corresponding to an optimum dough mixing time, said dough exhibiting subsequent viscoelasticities during continued mixing of the dough for a continued mixing period of from about 5-20 minutes beyond said optimum dough mixing time due to the presence of said additive, said subsequent viscoelasticities being within ±20% of said specific viscoelasticity.

61. The dough of claim 60, said specific and subsequent viscoelasticities being measured by mixograph analyses according to mixograph method 54-40A of the American Association of Cereal Chemists.

62. The dough of claim 60, wherein said continued mixing period is up to about 10 minutes.

63. The dough of claim 60, said subsequent viscoelasticities being within ±10% of said specific viscoelasticity.

64. The dough of claim 60, including a quantity of tyrosine bonds within said dough which has been altered as compared to the naturally occurring amount of tyrosine bonds.

65. The dough of claim 60, said additive being selected from the group consisting of peroxidase, alcohol, and combinations thereof.

66. A method of grading wheat comprising the steps of:
determining the level of active peroxidase in the glutenin fraction of the wheat; and
using said determined level to predict the quality of the wheat.

67. The method of claim 66, further comprising the step of determining the tyrosine or tyrosine bond level in the glutenin fraction of the wheat.

68. The method of claim 66, including the step of determining said peroxidase level at a plurality of times during the growth of said wheat.

69. The method of claim 67, said determining step comprising the steps of producing flour from the wheat and determining the peroxidase activity in said flour.

70. The method of claim 66, further comprising the step of comparing said determined level of peroxidase with a predetermined standard, said predetermined standard being correlated with a particular quality of wheat.

71. A method of altering dough forming characteristics of a grain comprising the step of manipulating the expression of active peroxidase in said grain.

72. The method of claim 71, said manipulating step being selected from the group consisting of altering the number of DNA sequences that code for peroxidase, increasing the expression of peroxidase, and decreasing the expression of the peroxidase.

73. The method of claim 71, said grain being selected from the group consisting of amaranth, barley, malting barley, buckwheat, canary seed, false melic grass, maize, millet, common millet, red millet, bulrush millet, foxtail millet, proso millet, finger millet, pearl millet, bulrush millet, cattail millet, fonio millet, oats, quinoa chenopodium spp quinoa, rice, wild rice, rye, sorghum, and kamut.

74. The method of claim 71, further including the step of manipulating the expression of tyrosine by said grain.

75. The method of claim 74, said manipulation of the expression of tyrosine bonds being accomplished by a method selected from the group consisting of altering the number of DNA sequences that code for tyrosine, increasing the expression of tyrosine, and decreasing the expression of tyrosine.

76. A method of forming a wheat-like dough using a grain other than wheat, said method comprising the step of modifying the expression of active peroxidase by said grain.

77. The method of claim 76, said modifying step being selected from the group consisting of adding peroxidase coding sequences to said grain, increasing the expression of active peroxidase coding in said grain, and combinations thereof.

78. The method of claim 76, further including the step of increasing the amount of tyrosine in the storage proteins of said grain.

79. The method of claim 76, said grain being selected from the group consisting of amaranth, barley, malting barley, buckwheat, canary seed, false melic grass, maize, millet, common millet, red millet, bulrush millet, foxtail millet, proso millet, finger millet, pearl millet, bulrush millet, cattail millet, fonio millet, oats, quinoa chenopodium spp quinoa, rice, wild rice, rye, sorghum, and kamut.

80. A method of breeding wheat comprising the steps of:
determining the amount of active peroxidase in wheat; and
selecting wheat for breeding based on said determined amount of active peroxidase in said wheat.

81. The method of claim 79, said determined amount being selected from the group consisting of the amount of active peroxidase expressed by said wheat and the amount of peroxidase coding sequences in said wheat.

82. A method of delaying the staling process in a dough product, said method comprising the steps of:
mixing flour and water to form a dough;
adding an amount of a peroxidase inhibiting ingredient, said peroxidase inhibiting ingredient operable to be released under a certain processing condition; and
processing said dough into said dough product.

83. The method of claim 82, said peroxidase inhibiting ingredient being selected from the group consisting of protease xylitol, sorbitol, glycerol, mannitol, and ascorbic acid.

84. The method of claim 82, said peroxidase inhibiting ingredient being encapsulated.

85. The method of claim 82, said processing condition being selected from the group consisting of time, temperature, pH, and hydration.

86. A method of altering a crosslinking property of a protein comprising the step of genetically altering a gene which expresses the protein in order to cause the altered gene to express a greater or lesser number of peroxidase enzymes.

87. The method of claim 86, said peroxidase enzymebeing selected from the group consisting of WP 1, NADH₂ peroxidase fatty-acid peroxidase, tryptophan 2,3-dioxygenase, cytochrome-c peroxidase, catalase, peroxidase, iodide peroxidase, glutathione peroxidase, chloride peroxidase, L-ascorbate peroxidase, phospholipid-hydroperoxide glutathione peroxidase, manganese peroxidase, diarylpropane peroxidase, and sequences which include the sequence of SEQ ID No. 7.

88. A method of producing a form of peroxidase in an organism which does not naturally produce said peroxidase, said method comprising the steps of:
inserting the gene encoding for said peroxidase in said organism; and
causing said organism to express said peroxidase.

89. The method of claim 88, said organism being selected from the group consisting of yeast or bacteria.
